(19) United States
(12) Patent Application Publication
(10) Pub. No.: US 2013/0100327 A1
(43) Pub. Date: Apr. 25, 2013

(54) IMAGE PICKUP UNIT AND IMAGE PICKUP DISPLAY SYSTEM

(71) Applicant: Sony Corporation, Tokyo (JP)

(72) Inventors: Michiru Senda, Kanagawa (JP); Yuichiro Minami, Kanagawa (JP)

(73) Assignee: Sony Corporation, Tokyo (JP)

(21) Appl. No.: 13/650,276

(22) Filed: Oct. 12, 2012

(30) Foreign Application Priority Data
Oct. 19, 2011 (JP) 2011-230128

(51) Int. Cl. H04N 5/335

(52) U.S. Cl. 348/301; 348/E05.091

(57) ABSTRACT

An image pickup unit includes: an image pickup section having a plurality of pixels each including a photoelectric transducer; and a drive section performing reading driving and reset driving of signal charge stored in each of the pixels. The drive section includes a charge amplifier circuit converting the read signal charge into a voltage, the drive section performs the reset driving a plurality of times intermittently during one frame period, and the drive section performs each reset driving within the one frame period, by using feedback or an imaginary short of a charge amplifier in the charge amplifier circuit.

### BACKGROUND

The disclosure relates to an image pickup unit having a photoelectric transducer, and an image pickup display system provided with such an image pickup unit.

Various kinds of units have been suggested as an image pickup unit having a photoelectric transducer built in each pixel (an image pickup pixel). Examples of such an image pickup unit with the photoelectric transducer include a so-called optical touch panel and a radiation image-pickup unit (see, for instance, Japanese Unexamined Patent Application Publication No. 2011-135561).

### SUMMARY

In the image pickup unit as described above, in general, image pickup data is obtained by performing reading driving and reset driving of signal charge for a plurality of pixels. However, there is a disadvantage that, due to this reset driving, noise occurs in an output signal, thereby degrading the quality of a picked-up image.

It is desirable to provide an image pickup unit capable of achieving higher quality of a picked-up image, and an image pickup display system with such an image pickup unit.

According to an embodiment of the disclosure, there is provided an image pickup unit including: an image pickup section having a plurality of pixels each including a photoelectric transducer; and a drive section performing reading driving and reset driving of signal charge stored in each of the pixels. The drive section includes a charge amplifier circuit converting the read signal charge into a voltage. Further, the drive section performs the reset driving a plurality of times intermittently during one frame period. Furthermore, the drive section performs each reset driving within the one frame period, by using feedback or an imaginary short of a charge amplifier in the charge amplifier circuit.

According to an embodiment of the disclosure, there is provided an image pickup display system that includes an image pickup unit and a display unit performing image display based on an image signal obtained by this image pickup unit. The image pickup unit includes: an image pickup section having a plurality of pixels each including a photoelectric transducer; and a drive section performing reading driving and reset driving of signal charge stored in each of the pixels. The drive section includes a charge amplifier circuit converting the read signal charge into a voltage, the drive section performs the reset driving a plurality of times intermittently during one frame period, and the drive section performs each reset driving within the one frame period, by using feedback or an imaginary short of a charge amplifier in the charge amplifier circuit.

In the image pickup unit and the image pickup display system according to the above-described embodiments of the disclosure, photoelectric conversion based on incident light is performed in each of the pixels of the image pickup section, and the reading driving and the reset driving of the signal charge are performed. Thereby, a picked-up image based on the incident light is obtained. The drive section includes the charge amplifier circuit that converts the read signal charge into the voltage. The drive section performs the reset driving a plurality of times intermittently during the one frame period, and performs each reset driving by using the feedback or the imaginary short in the charge amplifier circuit. Thus, a reduction in noise due to remaining of the signal charge after the reading is allowed.

According to the image pickup unit and the image pickup display system in the above-described embodiments of the disclosure, each of the pixels of the image pickup section includes the photoelectric transducer, and the drive section performs the reading driving and the reset driving of the signal charge derived from each of the pixels. Thereby, the picked-up image based on the incident light is obtained. The drive section includes the charge amplifier circuit that converts the read signal charge into the voltage. The drive section performs the reset driving a plurality of times intermittently during the one frame period, and performs each reset driving by using the feedback or the imaginary short in the charge amplifier circuit. This allows the noise resulting from the remaining of the signal charge after the reading to be reduced. Therefore, higher quality of the picked-up image is achievable.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve used to describe the principles of the technology.

FIG. 1 is a block diagram illustrating an overall configuration example of an image pickup unit according to a first embodiment of the disclosure.

FIG. 2 is a schematic diagram illustrating a schematic configuration example of an image pickup section depicted in FIG. 1.

FIG. 3 is a circuit diagram illustrating a detailed configuration example of each of a pixel circuit and a charge amplifier circuit depicted in FIG. 1.

FIG. 4 is a block diagram illustrating a detailed configuration example of a row scanning section depicted in FIG. 1.

FIGS. 5A and 5B are circuit diagrams each illustrating a configuration example of a buffer circuit depicted in FIG. 4.

FIG. 6 is a block diagram illustrating a detailed configuration example of a column selection section depicted in FIG. 1.

FIGS. 7A and 7B are a circuit diagram illustrating an example of an operation state in an exposure period, and a circuit diagram illustrating an example of an operation state in a reading/first reset period, respectively.

Part (A) and Part (B) of FIG. 8 are schematic diagrams used to describe a storage state and a depletion state, respectively, in a PIN photodiode having a lateral-type structure.

FIG. 9 is a cross-sectional schematic diagram illustrating an example of a PIN photodiode having a vertical-type structure.

Part (A) and Part (B) of FIG. 10 are characteristic diagrams used to describe a mechanism of signal charge remaining.

FIGS. 11A and 11B are characteristic diagrams illustrating an example of a relationship between time elapsed from the reading/first reset period and a Decay current.

FIG. 12 is a characteristic diagram used to describe a relationship between the amount of remaining charge and the Decay current.

FIG. 13 is a circuit diagram used to describe a charge distribution phenomenon (charge injection).

FIG. 14 is a timing chart used to describe a summary of line-sequential image pickup operation according to the embodiment.

Part (A) to Part (F) of FIG. 15 are diagrams illustrating timing waveforms used to describe the details of the line-sequential image pickup operation.

Part (A) to Part (E) of FIG. 16 are enlarged diagrams illustrating part of the timing waveforms depicted in FIG. 15.

Part (A) to Part (E) of FIG. 17 are diagrams illustrating timing waveforms in another example of the line-sequential image pickup operation according to the embodiment.

Part (A) to Part (E) of FIG. 18 are diagrams illustrating timing waveforms in still another example of the line-sequential image pickup operation according to the embodiment.

Part (A) to Part (D) of FIG. 19 are diagrams illustrating timing waveforms used to describe the image pickup operation for one line.

FIGS. 20A and 20B are circuit diagrams each illustrating an example of an operation state in a second reset period.

FIG. 21 is a characteristic diagram used to describe the amount of remaining charge reduced by the second reset operation.

FIG. 22 is a circuit diagram illustrating a configuration of each of a pixel circuit and a charge amplifier circuit according to a second embodiment of the disclosure.

FIG. 23 is a circuit diagram illustrating an example of an operation state in an exposure period of the second embodiment.

FIG. 24 is a circuit diagram illustrating an example of an operation state in a reading/first reset period of the second embodiment.

FIG. 25 is a circuit diagram illustrating an example of an operation state in a second reset period (using feedback) of the second embodiment.

FIG. 26 is a circuit diagram illustrating another example of the operation state in the second reset period (using an imaginary short) of the second embodiment.

FIG. 27 is a circuit diagram illustrating a configuration of each of a pixel circuit and a charge amplifier circuit according to a modification 1.

FIG. 28 is a circuit diagram illustrating an example of the operation state in the exposure period of the modification 1.

FIG. 29 is a circuit diagram illustrating an example of the operation state in the reading/first reset period of the modification 1.

FIG. 30 is a circuit diagram illustrating an example of the operation state in the second reset period of the modification 1.

FIG. 31 is a circuit diagram illustrating a configuration of each of a pixel circuit and a charge amplifier circuit according to a modification 2.

FIG. 32 is a circuit diagram illustrating a configuration of each of a pixel circuit and a charge amplifier circuit according to a modification 3.

FIGS. 33A and 33B are a schematic diagram illustrating a schematic configuration of an image pickup section according to a modification 4, and a schematic diagram illustrating a schematic configuration of an image pickup section according to a modification 5, respectively.

FIG. 34 is a schematic diagram illustrating a schematic configuration of an image pickup display system according to an application example.

### DETAILED DESCRIPTION

Embodiments of the disclosure will be described in detail with reference to the drawings. It is to be noted that the description will be provided in the following order.
1. First embodiment (an example of an image pickup unit that performs reset driving, by using feedback or an imaginary short of a charge amplifier circuit)
2. Second embodiment (an example in which a capacitor capacity of a charge amplifier circuit is variable between a first reset operation and a second reset operation)
3. Modification 1 (another example of a charge amplifier circuit)
4. Modification 2 (another example of a passive pixel circuit)
5. Modification 3 (Still another example of a passive pixel circuit)
6. Modifications 4 and 5 (each example of an image pickup section that performs image pickup based on radiation)
7. Application example (an example of application to an image pickup display system)

### FIRST EMBODIMENT

### [Overall Configuration of Image Pickup Unit 1]

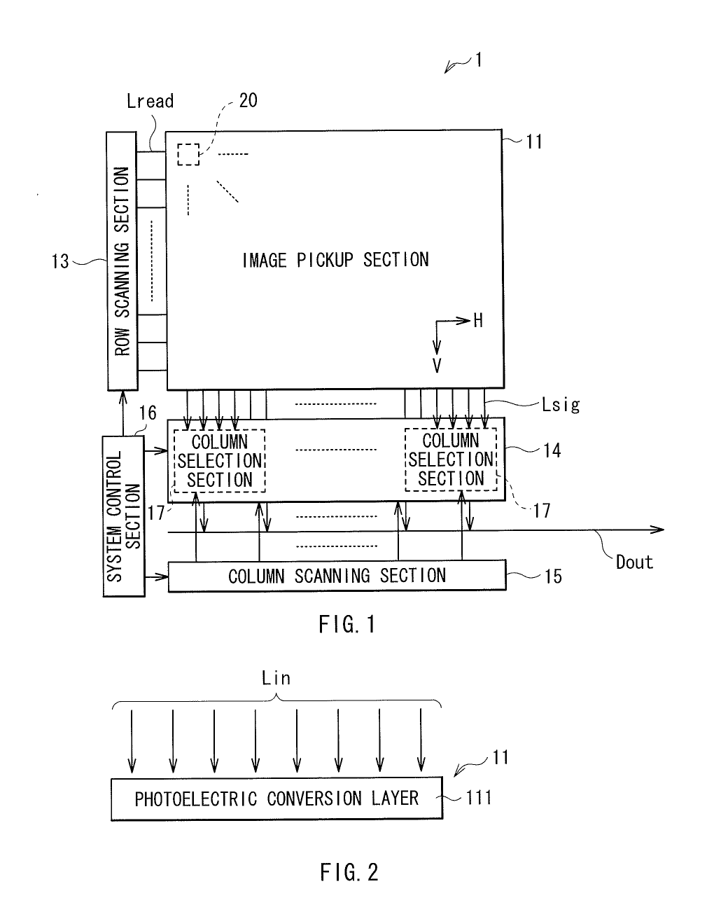

FIG. 1 illustrates an overall block configuration of an image pickup unit (an image pickup unit 1) according to a first embodiment of the disclosure. The image pickup unit 1 reads information about (picks up an image of) a subject based on incident light (image pickup light). The image pickup unit 1 includes an image pickup section 11, a row scanning section 13, an A/D conversion section 14, a column scanning section 15, and a system control section 16. Of these, the row scanning section 13, the A/D conversion section 14, the column scanning section 15, and the system control section 16 correspond to a specific but not limitative example of “drive section” in the disclosure. In addition, in the present embodiment, the A/D conversion section 14 (a column selection section 17 described later in detail) of this “drive section” includes “charge amplifier circuit” (a charge amplifier circuit 17A which will be described later) in the disclosure.

### (Image Pickup Section 11)

The image pickup section 11 generates an electric signal in response to incident light (image pickup light). In this image pickup section 11, pixels (image pickup pixels, unit pixels) 20 are arranged two-dimensionally in rows and columns (in a matrix). Each of the pixels 20 includes a photoelectric transducer (a photoelectric transducer 21 described later). The photoelectric transducer generates photocharge in an amount corresponding to a quantity of the image pickup light, and stores the photocharge inside thereof. It is to be noted that as illustrated in FIG. 1, the description will be provided below by referring to a horizontal direction (a row direction) in the image pickup section 11 as an “H” direction and a vertical direction (a column direction) as a “V” direction.

FIG. 2 illustrates a schematic configuration example of the image pickup section 11. The image pickup section 11 includes a photoelectric conversion layer 111 where the photoelectric transducer 21 is arranged for each of the pixels 20. In the photoelectric conversion layer 111, photoelectric conversion based on image pickup light Lin incident thereon (i.e. conversion from the image pickup light Lin into signal charge) is performed, as illustrated in the figure.

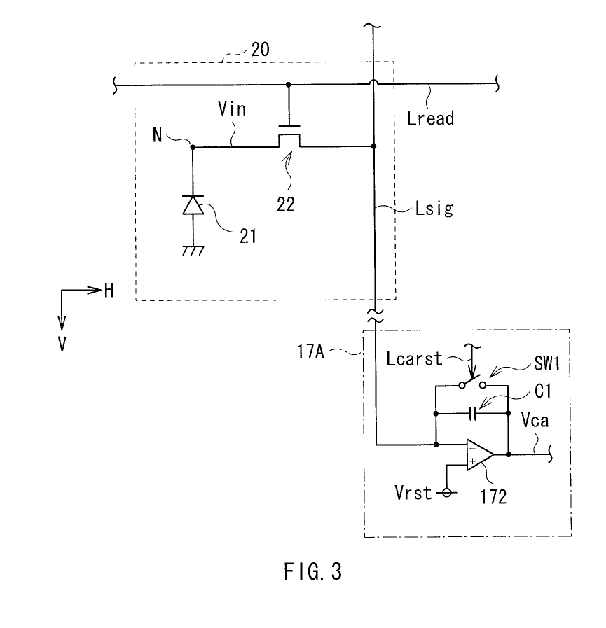

FIG. 3 illustrates an example of a circuit configuration (a so-called passive circuit configuration) of the pixel 20, together with a charge amplifier circuit (the charge amplifier circuit 17A) in the A/D conversion section 14 (the column selection section 17). This passive pixel 20 is provided with the one photoelectric transducer 21 and one transistor 22. Further, a reading control line Lread extending along the H direction and a signal line Lsig extending along the V direction are connected to this pixel 20.

The photoelectric transducer 21 is, for example, a Positive Intrinsic Negative (PIN) photodiode or a Metal-Insulator-Semiconductor (MIS) sensor. As mentioned above, the photoelectric transducer 21 generates the signal charge in an amount corresponding to the quantity of the incident light (the image pickup light Lin). It is to be noted that, here, a cathode of this photoelectric transducer 21 is connected to a storage node N.

The transistor 22 is a transistor (a read transistor) that outputs signal charge (an input voltage Vin) obtained by the photoelectric transducer 21 to the signal line Lsig, by entering an ON state in response to a row scanning signal supplied through the reading control line Lread. Here, the transistor 22 is configured using an N-channel-type (N-type) Field Effect Transistor (FET). Alternatively, the transistor 22 may be configured using a P-channel-type (P-type) FET or the like. Further, the transistor 22 is configured using, for example, a silicon system semiconductor such as amorphous silicon, micro-crystal silicon, and polycrystal silicon (polysilicon). Alternatively, the transistor 22 may be configured using an oxide semiconductor such as indium gallium zinc oxide (InGaZnO) and zinc oxide (ZnO). In the circuit configuration of the pixel 20, a gate of the transistor 22 is connected to the reading control line Lread, a source is connected to, for example, the signal line Lsig, and a drain is connected to, for example, the cathode of the photoelectric transducer 21 through the storage node N. In addition, an anode of the photoelectric transducer 21 is connected to the ground (grounded).

### (Row Scanning Section 13)

The row scanning section 13 is configured to include, for example, a shift register circuit described later, a predetermined logical circuit, and the like. The row scanning section 13 is a pixel driving section (a row scanning circuit) that performs driving of the pixels 20 row by row (for each of horizontal lines) in the image pickup section 11 (i.e. line-sequential scanning). Specifically, the row scanning section 13 performs image pickup operation such as reading operation and reset operation described later, by, for example, line-sequential scanning. It is to be noted that this line-sequential scanning is performed by supplying the above-described row scanning signal to each of the pixels 20 through the reading control line Lread.

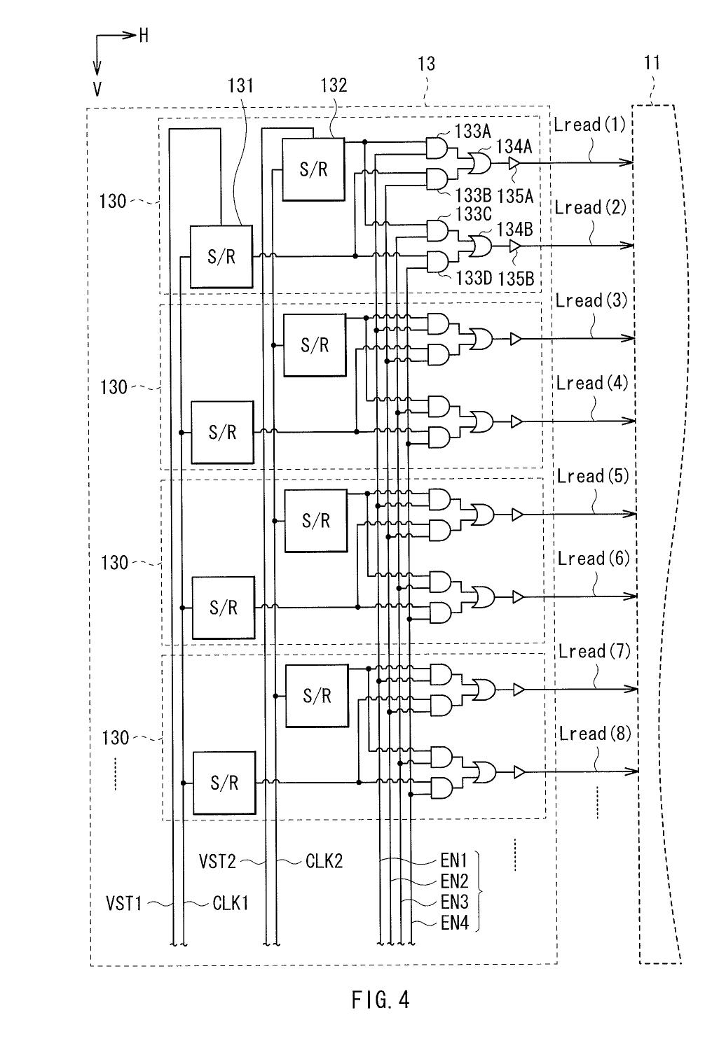

FIG. 4 illustrates a block configuration example of the row scanning section 13. The row scanning section 13 includes a plurality of unit circuits 130 extending along the V direction. It is to be noted that, here, the eight reading control lines Lread connected to the four unit circuits 130 illustrated in the figure are indicated with Lread (1) to Lread (8) sequentially from the top.

Each of the unit circuits 130 includes shift register circuits (which are indicated with “S/R” in the figure for convenience sake, and the same hereinafter) 131 and 132 in a plurality of columns (here, in two columns). Each of the unit circuits 130 further includes four AND circuits 133A to 133D, two OR circuits 134A and 134B, and two buffer circuits 135A and 135B.

The shift register circuit 131 generates a pulse signal based on a start pulse VST1 and a clock signal CLK1 which are supplied from the system control section 16. The pulse signal sequentially shifts in the V direction, for the plurality of unit circuits 130 as a whole. Similarly, the shift register circuit 132 generates a pulse signal based on a start pulse VST2 and a clock signal CLK2 which are supplied from the system control section 16, and this pulse signal sequentially shifts in the V direction, for the plurality of unit circuits 130 as a whole. The shift register circuits 131 and 132 are provided corresponding to the number of times (e.g., twice) reset driving described later is to be performed (i.e., the shift register circuits 131 and 132 are provided in two columns corresponding to the number of times the reset driving is to be performed). In other words, for example, the shift register circuit 131 generates the pulse signal for the first reset driving, and the shift register circuit 132 generates the pulse signal for the second reset driving.

Four enable signals EN1 to EN4 used to control (regulate) a validity period of each pulse signal (each output signal) outputted from each of the shift register circuits 131 and 132 are inputted into the AND circuits 133A to 133D, respectively. Specifically, in the AND circuit 133A, the pulse signal outputted from the shift register circuit 132 is inputted into one input terminal, and the enable signal EN1 is inputted into the other input terminal. In the AND circuit 133B, the pulse signal outputted from the shift register circuit 131 is inputted into one input terminal, and the enable signal EN2 is inputted into the other input terminal. In the AND circuit 133C, the pulse signal outputted from the shift register circuit 132 is inputted into one input terminal, and the enable signal EN3 is inputted into the other input terminal. In the AND circuit 133D, the pulse signal outputted from the shift register circuit 131 is inputted into one input terminal, and the enable signal EN4 is inputted into the other input terminal.

The OR circuit 134A generates a logical sum signal (an OR signal) between an output signal from the AND circuit 133A and an output signal from the AND circuit 133B. Similarly, the OR circuit 134B generates a logical sum signal between an output signal from the AND circuit 133C and an output signal from the AND circuit 133D. In this way, the logical sum signals each between the output signals (pulse signals) from the shift register circuits 131 and 132 are generated by the AND circuits 133A to 133D and the OR circuits 134A and 134B, while the validity period of each of the output signals is controlled. Thus, drive timing and the like at the time when the reset driving described later is performed a plurality of times are regulated.

The buffer circuit 135A functions as a buffer for the output signal (pulse signal) from the OR circuit 134A, and the buffer circuit 135B functions as a buffer for the output signal from the OR circuit 134B. The pulse signals (the row scanning signals) after the buffering by the buffer circuits 135A and 135B are outputted to each of the pixels 20 in the image pickup section 11, through the reading control lines Lread.

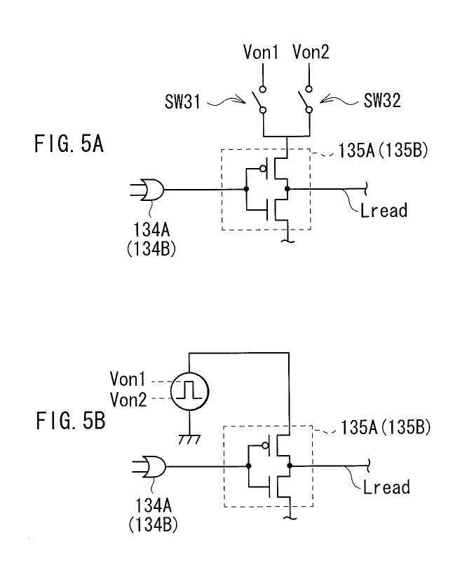

It is to be noted that as a voltage pulse applied to the reading control line Lread, a binary pulse changeable between two levels (between an ON electric potential on the high side and an OFF electric potential on the low side) is usually used. However, a ternary pulse changeable among three levels (two levels on the high side and one level on the low side) may be used, by employing the following circuit configuration. For example, it is possible to realize such ternary switching by employing, for example, a circuit configuration using switches (switches SW31 and SW32) as illustrated in FIG. 5A. Specifically, the switches SW31 and SW32 are provided on the high side of the buffer circuit 135A (135B), and a high-side voltage is changed to an electric potential Von1 by keeping the switch SW31 in an ON state and the switch SW32 in an OFF state. On the other hand, the high-side voltage is changed to an electric potential Von2 by keeping the switch SW31 in an OFF state and the switch SW32 in an ON state. Alternatively, as illustrated in FIG. 5B, a binary voltage pulse (Von1 and Von2) is formed outside of the image pickup unit 1, and this may be used as the high-side voltage. (A/D Converter 14)

The A/D conversion section 14 includes the plurality of column selection sections 17 each being provided for every plurality of (here, four) signal lines Lsig. The A/D conversion section 14 performs A/D conversion (analog to digital conversion) based on a signal voltage (signal charge) inputted through the signal line Lsig. Thus, the output data Dout formed of digital signals (i.e. image pickup signals) is generated, and outputted to the outside.

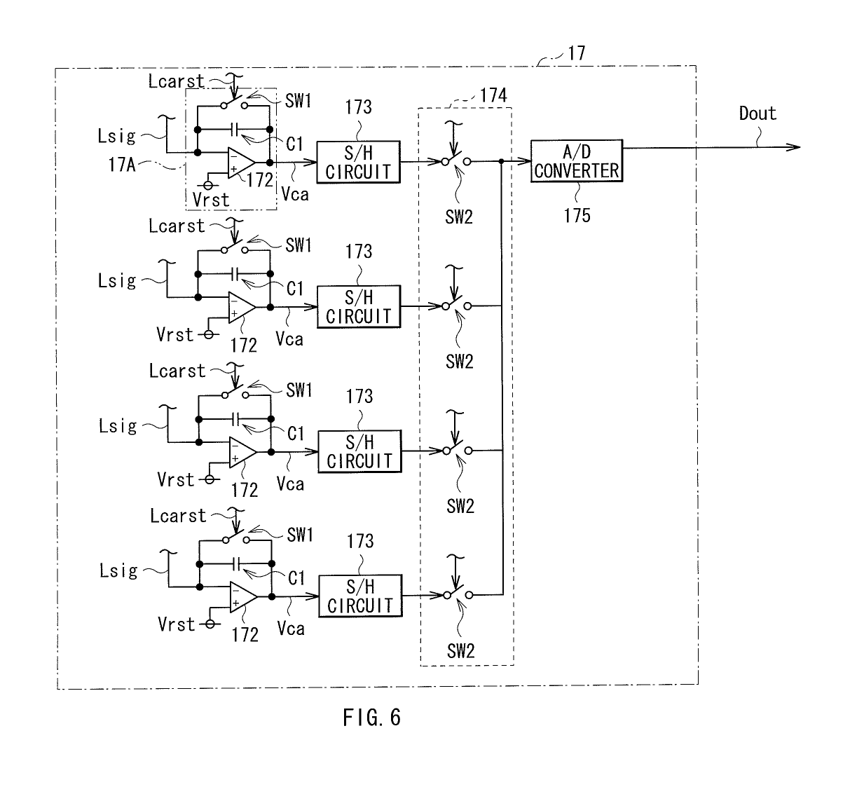

Each of the column selection sections 17 includes the charge amplifier circuit 17A, sample hold (S/H) circuits 173, a multiplexor circuit (a selection circuit) 174, and an A/D converter 175 as illustrated in FIG. 3 and FIG. 6, for example. The multiplexor circuit 174 includes four switches SW2. Of these, the charge amplifier circuit 17A is provided for each of the signal lines Lsig. The multiplexor circuit 174 and the A/D converter 175 are provided for each of the column selection sections 17. (Charge Amplifier Circuit 17A)

The charge amplifier circuit 17A includes, for example, a charge amplifier 172, a capacitive device (a capacitor, a feedback capacitive device) Cl, and a switch SW1. The charge amplifier 172 converts signal charge read from the signal line Lsig, into a voltage (i.e. performs Q-V conversion). In this charge amplifier 172, one end of the signal line Lsig is connected to an input terminal on a negative side (a minus side), and a predetermined reset voltage Vrst is inputted into an input terminal on a positive side (a plus side). Between an output terminal of the charge amplifier 172 and the input terminal on the negative side of the charge amplifier 172, feedback connection is established through a parallel connection circuit including the capacitive device C1 and the switch SW1. In other words, one terminal of the capacitive device C1 is connected to the input terminal on the negative side of the charge amplifier 172, and the other terminal of the capacitive device C1 is connected to the output terminal of the charge amplifier 172. Similarly, one terminal of the switch SW1 is connected to the input terminal on the negative side of the charge amplifier 172, and the other terminal of the switch SW1 is connected to the output terminal of the charge amplifier 172. It is to be noted that the ON/OFF state of this switch SW1 is controlled by a control signal (an amplifier reset control signal) supplied from the system control section 16 through an amplifier reset control line Lcarst.

The S/H circuit 173 is disposed between the charge amplifier 172 and the multiplexor circuit 174 (the switch SW2), and provided to temporarily hold an output voltage Vca supplied from the charge amplifier 172.

The multiplexor circuit 174 selectively makes or breaks connection between each of the S/H circuits 173 and the A/D converter 175, based on sequential turning ON of one of the four switches SW2 according to scanning driving performed by the column scanning section 15.

The A/D converter 175 generates and outputs the output data Dout mentioned above, by subjecting an output voltage inputted from the S/H circuit 173 through the switch SW2 to A/D conversion.

### (Column Scanning Section 15)

The column scanning section 15 is configured to include, for example, a shift register, an address decoder, and the like which are not illustrated. The column scanning section 15 sequentially drives each of the switches SW2 in the column selection section 17 while scanning each of the switches SW2. Through such selection scanning performed by the column scanning section 15, the signal (the output data Dout) of each of the pixels 20 read through each of the signal lines Lsig is sequentially outputted to the outside.

### (System Control Section 16)

The system control section 16 controls operation of each of the row scanning section 13, the A/D conversion section 14, and the column scanning section 15. Specifically, the system control section 16 includes a timing generator generating various timing signals (control signals) described above, and controls driving of the row scanning section 13, the A/D conversion section 14, and the column scanning section 15, based on these various timing signals generated by the timing generator. Based on this control of the system control section 16, each of the row scanning section 13, the A/D conversion section 14, and the column scanning section 15 performs image pickup driving (line-sequential image pickup driving) for the plurality of pixels 20 in the image pickup section 11. The output data Dout is thereby acquired from the image pickup section 11.

### [Function and Effects of Image Pickup Unit 1]

In the image pickup unit 1 of the present embodiment, when the image pickup light Lin is incident on the image pickup section 11, this image pickup light Lin is converted into signal charge (i.e. subjected to photoelectric conversion) in the photoelectric transducer 21 in each of the pixels 20. At this moment, in the storage node N, a voltage variation corresponding to a node capacity occurs due to storage of the signal charge generated by the photoelectric conversion. Specifically, when a storage node capacity is assumed to be “Cs” and the generated signal charge is assumed to be “q”, the voltage varies (decreases in this case) by (q/Cs) in the storage node N. In response to such a voltage variation, the input voltage Vin (the voltage corresponding to the signal charge) is applied to the drain of the transistor 22. Upon the transistor 22 entering the ON state in response to the row scanning signal supplied through the reading control line Lread, the input voltage Vin supplied to the transistor 22 (the signal charge stored in the storage node N) is read from the pixel 20 to the signal line Lsig.

The read signal charge is inputted into the column selection section 17 in the A/D conversion section 14, for every plurality of (here, four) pixel columns through the signal line Lsig. In the column selection section 17, at first, the Q-V conversion (the conversion from the signal charge to the signal voltage) is performed in the charge amplifier circuit 17A, for every signal charge inputted through each of the signal lines Lsig. Next, for every converted signal voltage (the output voltage Vca from the charge amplifier 172), the A/D conversion is performed in the A/D converter 175 through the S/H circuit 173 and the multiplexor circuit 174, thereby generating the output data Dout formed of digital signals (i.e. the image pickup signals). In this way, the output data Dout is sequentially outputted from each of the column selection sections 17, and transmitted to the outside (or, inputted into an internal memory not illustrated). This image pickup driving operation will be described below in detail.

### (Operation in Exposure Period and Reading Period)

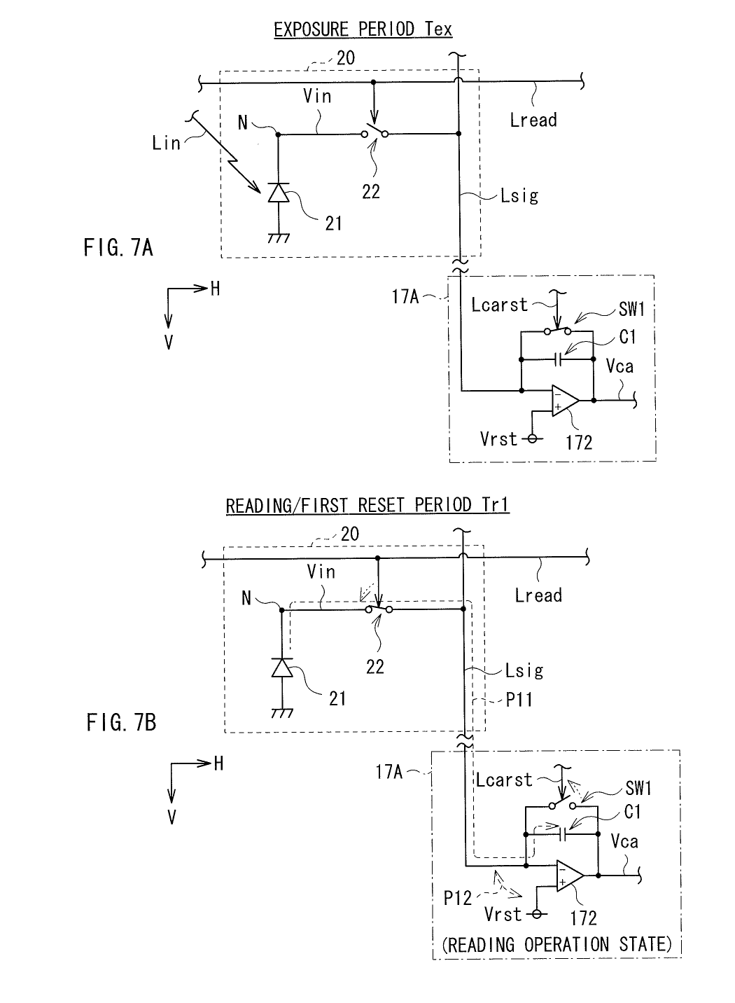

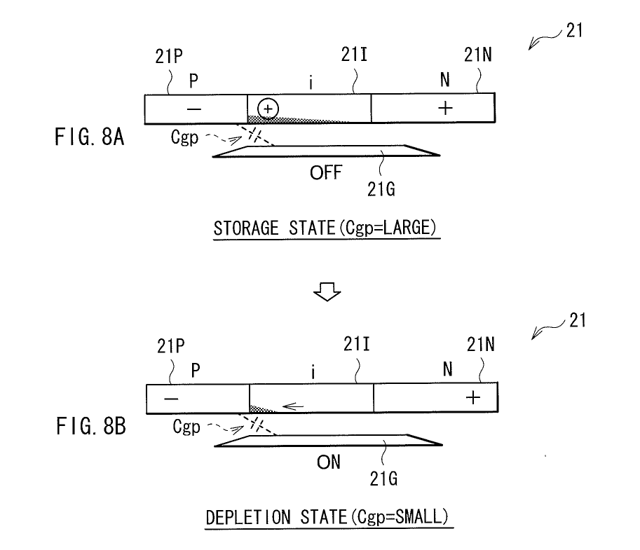

FIG. 7A illustrates an operation example of each of the pixel 20 and the charge amplifier circuit in the column selection section 17 in an exposure period, and FIG. 7B illustrates that in a reading period. It is to be noted that for the following description, the ON/OFF state of the transistor 22 is illustrated using a switch for convenience of description.

First, the transistor 22 is in the OFF state during an exposure period Tex, as illustrated in FIG. 7A. In this state, the signal charge based on the image pickup light Lin incident on the photoelectric transducer 21 in the pixel 20 is stored in the storage node N, without being outputted to the signal line Lsig side (i.e. without being read out). Meanwhile, the charge amplifier circuit is in a state after amplifier reset operation (reset operation of the charge amplifier circuit) described later being carried out. Therefore, the switch SW1 is in the ON state, and as a result, a voltage follower circuit is formed.

After this exposure period Tex, operation of reading the signal charge from the pixel 20 (i.e. reading operation) is performed, and also, operation (reset operation, pixel reset operation) intended to reset (discharge) the signal charge stored in the pixel 20 is performed. In the present embodiment, the pixel 20 includes a passive pixel circuit and therefore, the reset operation is carried out accompanying the reading operation mentioned above. It is to be noted that this reset operation corresponds to first-time reset operation (first reset operation) of the reset operation performed a plurality of times which will be described later. Therefore, in the following description, this reading period will be simply referred to as “reading/first reset period Tr1” or “period Tr1”.

Specifically, as illustrated in FIG. 7B, during the reading/first reset period Tr1, the signal charge is read from the storage node N in the pixel 20 to the signal line Lsig side when the transistor 22 enters the ON state (see an arrow P11 in the figure). The signal charge thus read is inputted into the charge amplifier circuit 17A. Meanwhile, in the charge amplifier circuit 17A, the switch SW1 is in the OFF state (the charge amplifier circuit 17A is in a reading operation state). Therefore, the signal charge inputted into the charge amplifier circuit 17A is stored in the capacitive device C1, and a signal voltage (the output voltage Vca) corresponding to the stored charge is outputted from the charge amplifier 172. It is to be noted that the electric charge stored in the capacitive device C1 is reset when the switch SW1 enters the ON state in the amplifier reset operation described later (the amplifier reset operation is performed).

During this reading/first reset period Tr1, the following reset operation (the first reset operation) is carried out accompanying the above-described reading operation. In other words, the first reset operation is performed using an imaginary short in the charge amplifier circuit (the charge amplifier 172) as indicated with an arrow P12 in the figure. Specifically, because of the imaginary short, the voltage on the input terminal side on the negative side (the signal line Lsig side) in the charge amplifier 172 becomes substantially equal to the reset voltage Vrst applied to the input terminal on the positive side. Therefore, the storage node N also becomes the reset voltage Vrst. In this way, in the present embodiment using the passive pixel circuit, the storage node N is reset to the predetermined reset voltage Vrst, accompanying the reading operation, during the reading/first reset period Tr1.

(Remaining of Signal Charge after Reading/Reset)

During the reading/first reset period Tr1, the reset operation is performed accompanying the reading operation, as described above. However, there is a case where a part of the signal charge stored before then remains (stays) in the pixel 20 even after this period Tr1. When a part of the signal charge remains in the pixel 20, an afterimage due to the remaining charge is generated in the next reading operation (at the time of the image pickup in the next frame period), thereby degrading the quality of a picked-up image. Such remaining of the signal charge will be described below in detail with reference to Part (A) of FIG. 8 to FIG. 13.

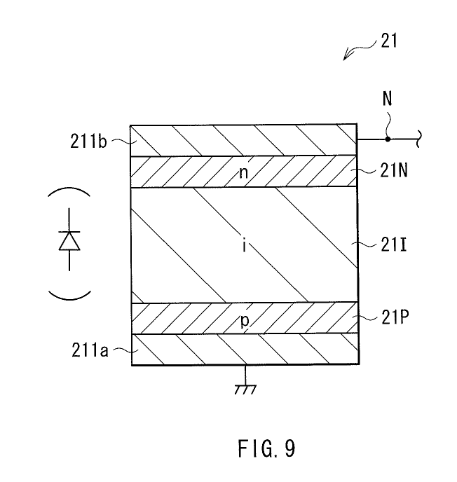

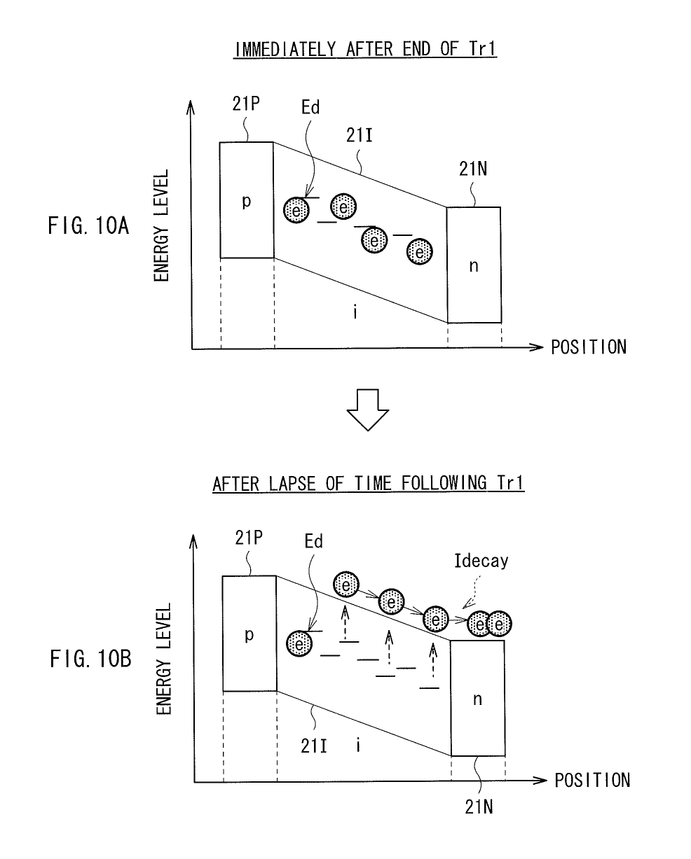

Here, when the photoelectric transducer 21 is a PIN photodiode (a thin film photodiode), photodiodes of this type are broadly divided into two types of structures. One is a so-called lateral-type structure as illustrated in Part (A) and Part (B) of FIG. 8, and the other is a so-called vertical-type structure as illustrated in FIG. 9.

In a case of employing the lateral-type structure, the photoelectric transducer 21 includes a p-type semiconductor layer 21P, an intrinsic semiconductor layer (an “i layer”) 211, and an n-type semiconductor layer 21N in this order along a lateral direction (a lamination in-plane direction). The photoelectric transducer 21 further includes a gate electrode 21G disposed in the vicinity of the intrinsic semiconductor layer 211 to face the intrinsic semiconductor layer 211, with a gate insulating film (not illustrated) interposed therebetween. On the other hand, in a case of employing the vertical-type structure, the photoelectric transducer 21 includes, for example, a lower electrode 211a, a p-type semiconductor layer 21P, an intrinsic semiconductor layer 211, an n-type semiconductor layer 21N, and an upper electrode 211b in this order along a vertical direction (a lamination direction). It is to be noted that in the following, the description will be provided assuming that the photoelectric transducer 21 is a PIN photodiode having the lateral-type structure of the above-described two types of structures.

### (Mechanism of Signal Charge Remaining)

One of conceivable reasons for the occurrence of the remaining of the electric charge described above is that the signal charge in the pixel 20 is saturated under the influence of external light (in particular, strong external light). In the photoelectric transducer 21, the intrinsic semiconductor layer 211 enters any of a storage state (a saturation state), a depletion state, and an inversion state, in response to a gate voltage applied to the gate electrode 21G. However, in a thin-film photodiode, it is necessary to have time on the order of several hundred microseconds to shift from a state where the electric charge is induced at an interface on the gate electrode 21G side in the storage state or the inversion state (Part (A) of FIG. 8) to the depletion state (Part (B) of FIG. 8). Usually, the PIN photodiode is used in the depletion state because photosensitivity is a maximum in the depletion state. However, for example, when entering a state of Vnp<0 V by being irradiated with strong external light, the PIN photodiode shifts to the storage state. It is to be noted that “Vnp” is an electric potential of the n-type semiconductor layer 21N seen from the p-type semiconductor layer 21P side.

Therefore, for example, even when an environment changes to a dark condition immediately after the irradiation of the strong external light, and also the PIN photodiode returns to a state of Vnp>0 upon the reset operation (the first reset operation), the PIN photodiode does not shift from the storage state to the depletion state during several hundred microseconds. Here, it is known that between the depletion state and the storage state or the inversion state, there is a difference in capacitance characteristics in the PIN photodiode, due to the influence of the electric charge induced at the interface on the gate electrode 21G side. Specifically, as illustrated in Part (A) and Part (B) of FIG. 8, a parasitic capacitance Cgp formed between the gate electrode 21G and the p-type semiconductor layer 21P is large in the storage state and small in the depletion state.

Here, in the PIN photodiode (the photoelectric transducer 21) connected to the storage node N, when the parasitic capacitances Cgp vary between the depletion state, the storage state, and the inversion state, the total coupling amount (the magnitude of the parasitic capacitance) in the pixel 20 changes due to such a state transition. Therefore, even after the reading/first reset period Tr1, information (electric charge) of light which has been incident until just before the period Tr1 remains in the storage node N. Based on such a mechanism, when the electric charge in the pixel 20 is saturated by the irradiation of the strong external light, a part of the signal charge stored until just before then remains in the pixel 20, even after the reading/first reset period Tr1 accompanied by the reset operation.

However, the above case (in which the electric charge is saturated under the influence of the strong external light) is not alone, and alternatively, the signal charge may remain for the following reason. That is, the charge may remain due to the generation of a Decay current from the photoelectric transducer 21 (the PIN photodiode).

Part (A) and Part (B) of FIG. 10 each illustrate an energy band structure (a relationship between the position and the energy level of each layer) in the PIN photodiode described above. As apparent from these figures, there are a large number of defect levels Ed in the intrinsic semiconductor layer 211. As illustrated in Part (A) of FIG. 10, electric charge “e” is in a state of being captured (trapped) by these defect levels Ed, immediately after the reading/first reset period Tr1. However, after a lapse of a certain period of time following the reading/first reset period Tr1, the electric charge “e” trapped by the defect levels Ed is released from the intrinsic semiconductor layer 211 to the outside of the photodiode (the photoelectric transducer 21) as illustrated in Part (B) of FIG. 10 (see arrows of broken lines in this figure), for example. As a result, the Decay current (a current Idecay) mentioned above is generated from the photoelectric transducer 21.

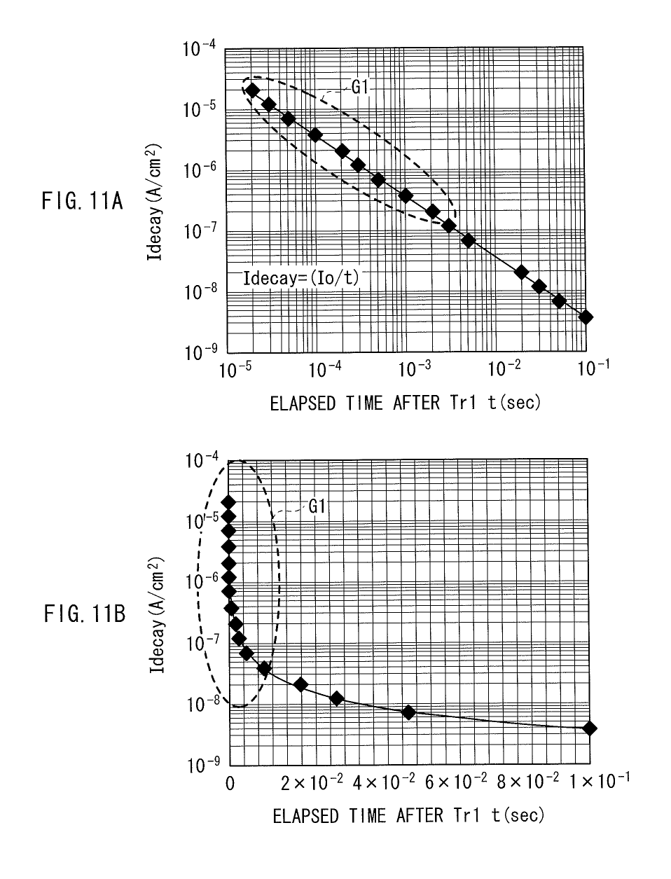

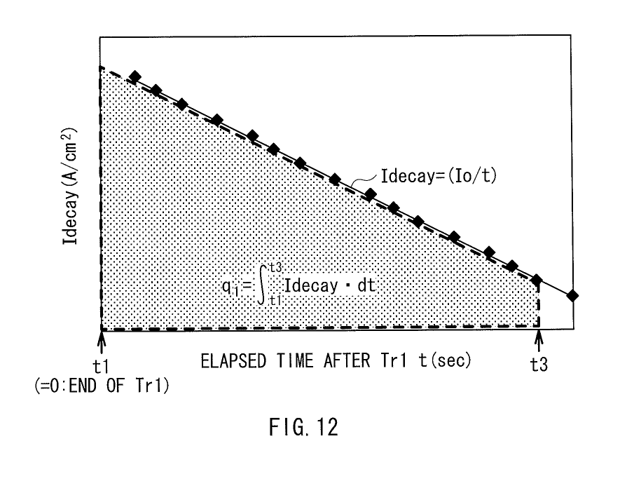

Here, FIGS. 11A and 11B illustrate an example of a relationship between elapsed time “t” following the reading/first reset period Tr1 and the current Idecay. In FIG. 11A, a vertical axis and a horizontal axis are each indicated with a logarithm (log) scale. In FIG. 11B, a vertical axis is indicated with a logarithm scale, and a horizontal axis is indicated with a linear scale. A part (G1) surrounded with a broken line in FIG. 11A and that in FIG. 11B correspond to each other. As apparent from these figures, the current Idecay tends to decrease synergistically with the passage of the time starting from (t=0) at the end of the reading/first reset period Tr1 (Idecay=(I_{O/t}), I_{O}: a constant value). Further, the remaining charge (assumed to be “q1”) generated at this moment is determined by finding an integral of the current Idecay=(I_{O/t}) with the elapsed time “t”, as illustrated in FIG. 12, for example. The remaining charge is generated in the pixel 20, also by such a Decay current generated from the photoelectric transducer 21.

For the above reasons (i.e. the pixel saturation by irradiation of the strong external light and the generation of the Decay current), the remaining charge q1 is generated in the pixel 20 even after the reading/first reset period Tr1 with the reset operation.

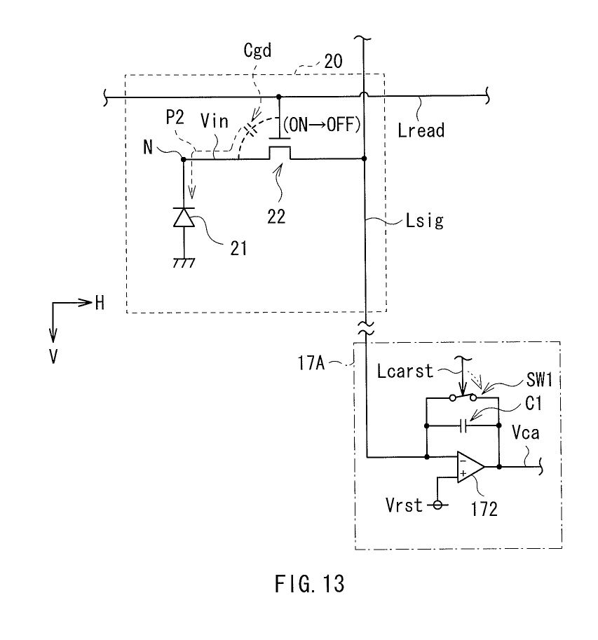

It is to be noted that an afterimage may occur due to the occurrence of so-called charge injection. In other words, in the storage node N in the pixel 20, the predetermined reset voltage Vrst is attained after the reading/first reset period Tr1, but after that, the transistor 22 shifts from the ON state to the OFF state. At this moment, as illustrated in FIG. 13, for instance, due to the stored electric charge in a parasitic capacitance (a parasitic capacitance Cgd formed between the gate and the drain of the transistor 22) in the pixel 20, the electric potential of the storage node N slightly changes from the reset voltage Vrst (see P2 in the figure). Here, since the storage node N is connected to the cathode side of the photoelectric transducer 21, an electric potential Vn drops from the reset voltage Vrst by a predetermined electric potential (an arrow P33 in Part (D) of FIG. 19 described later).

### (Reset Operation Performed Plurality of Times)

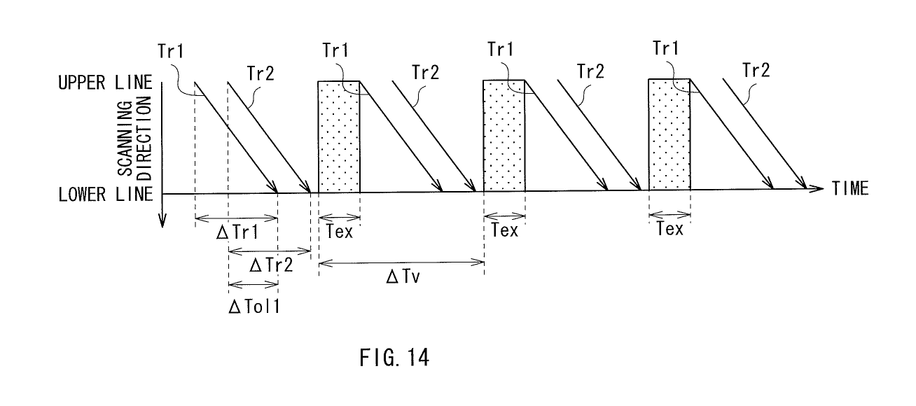

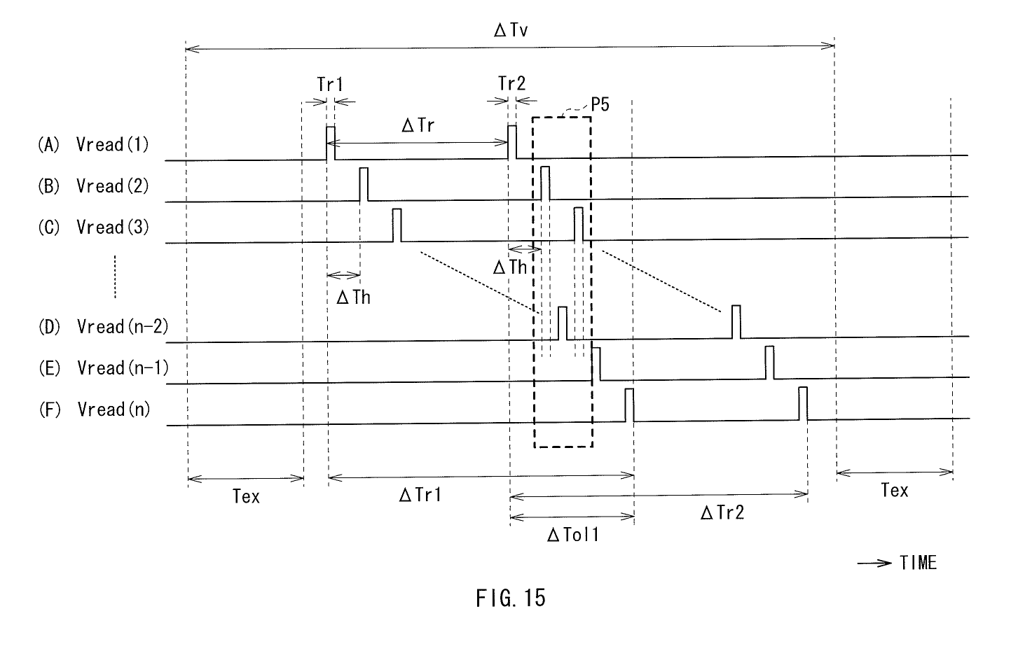

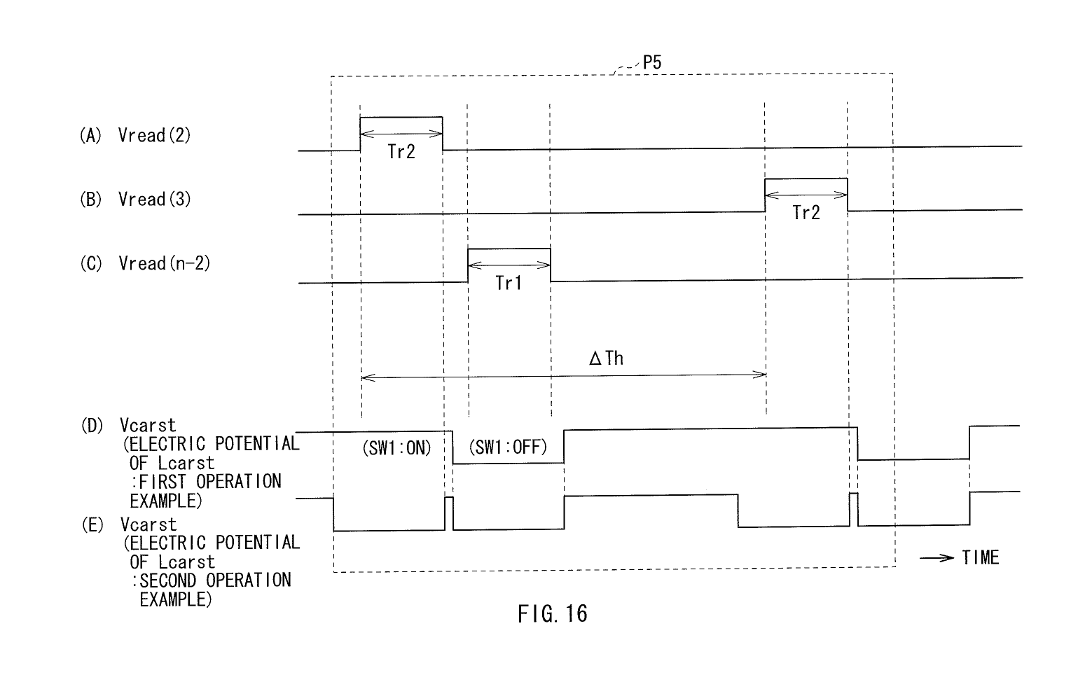

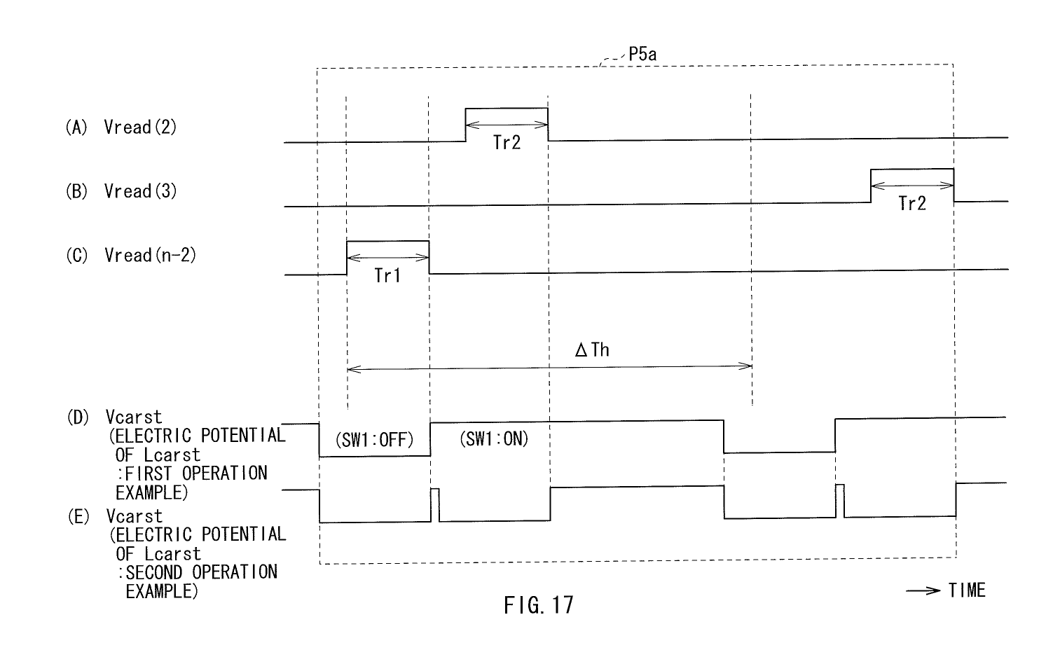

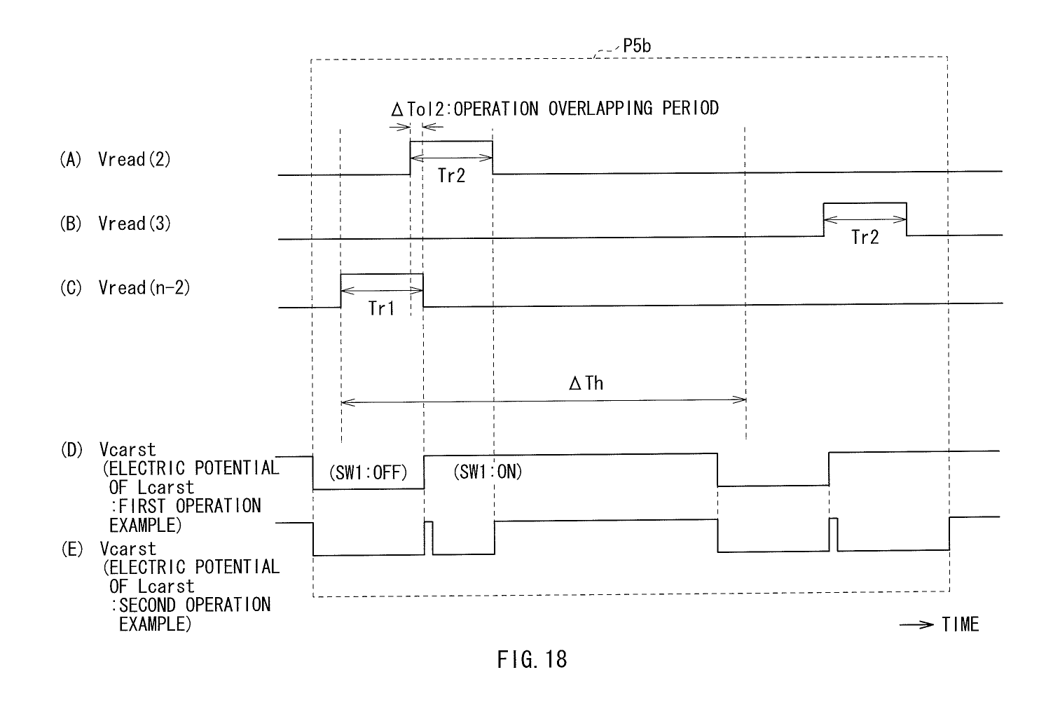

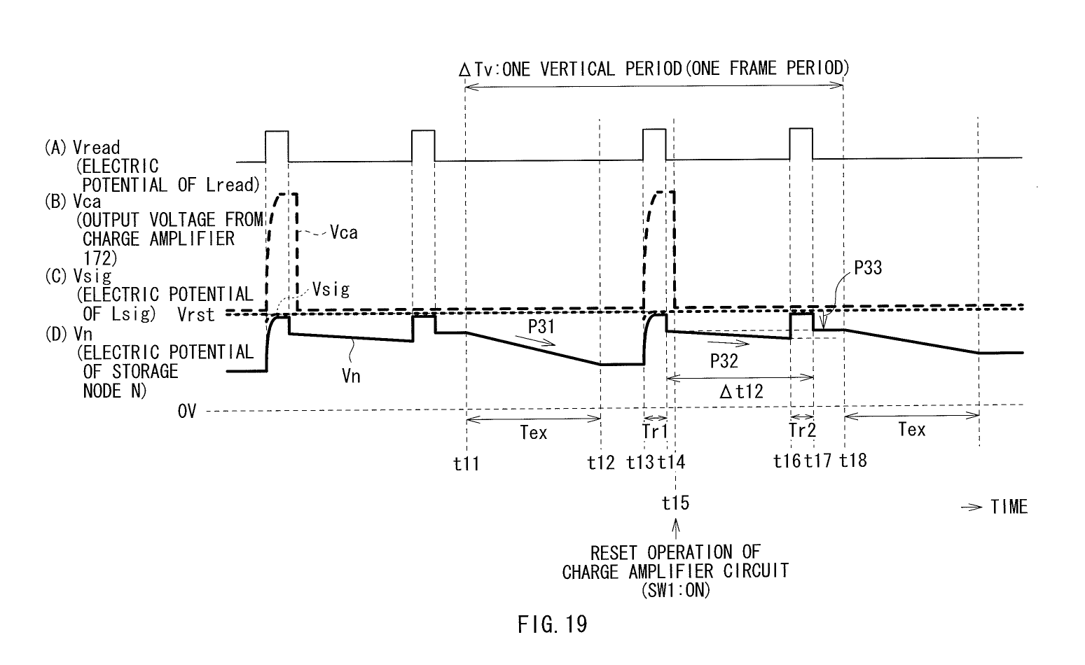

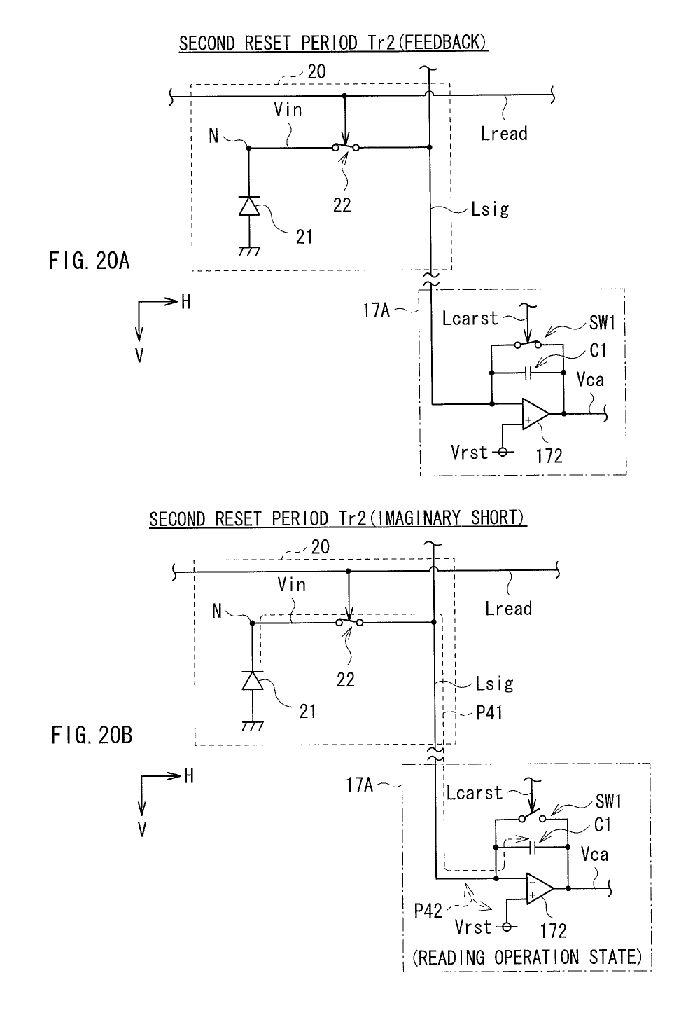

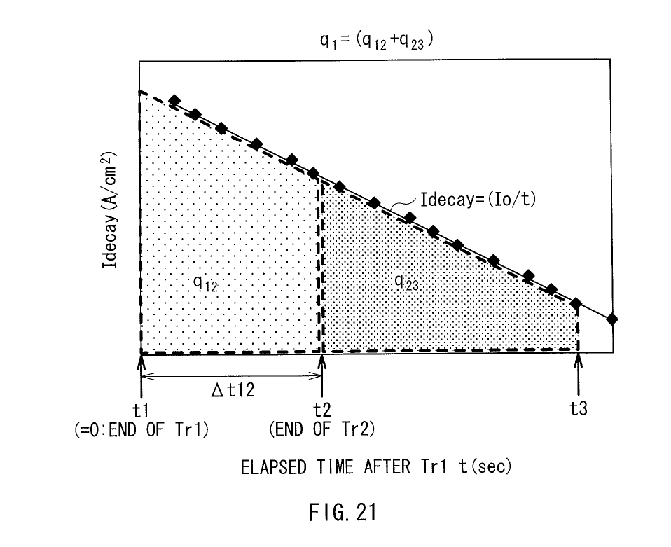

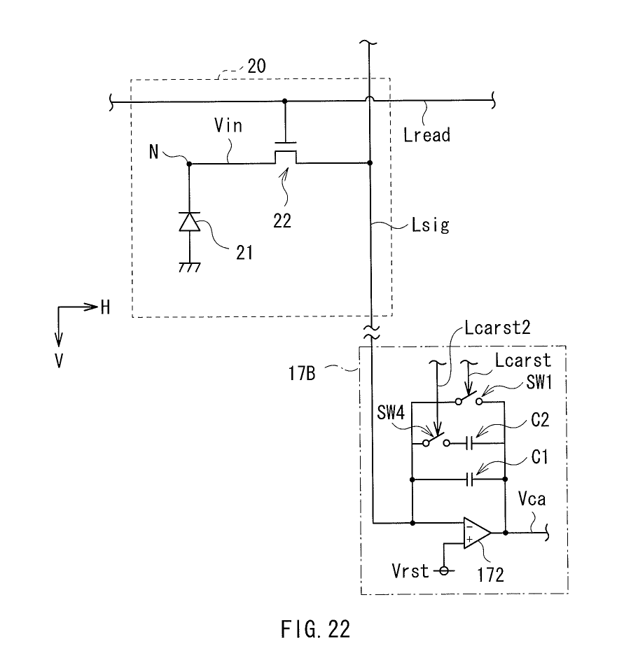

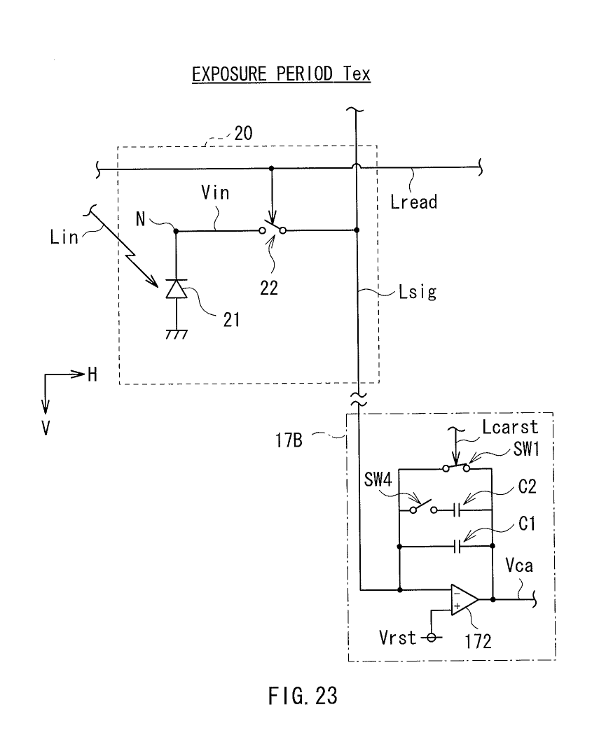

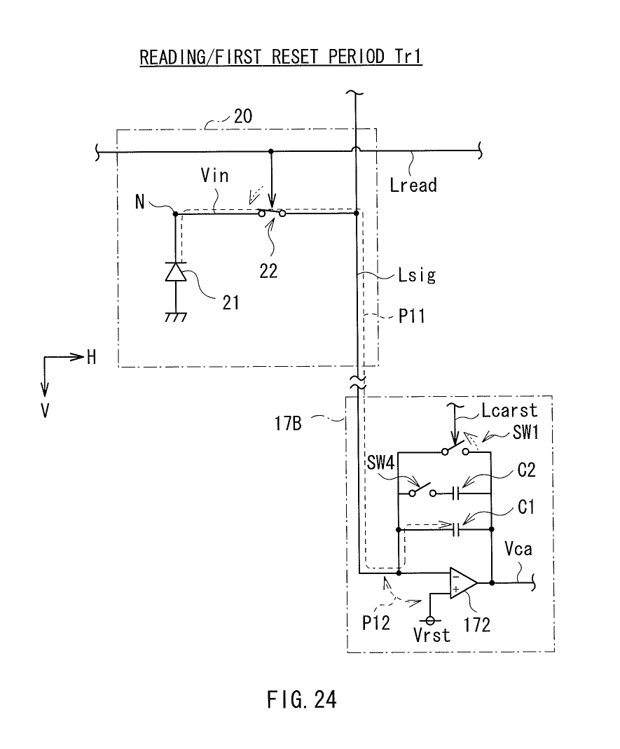

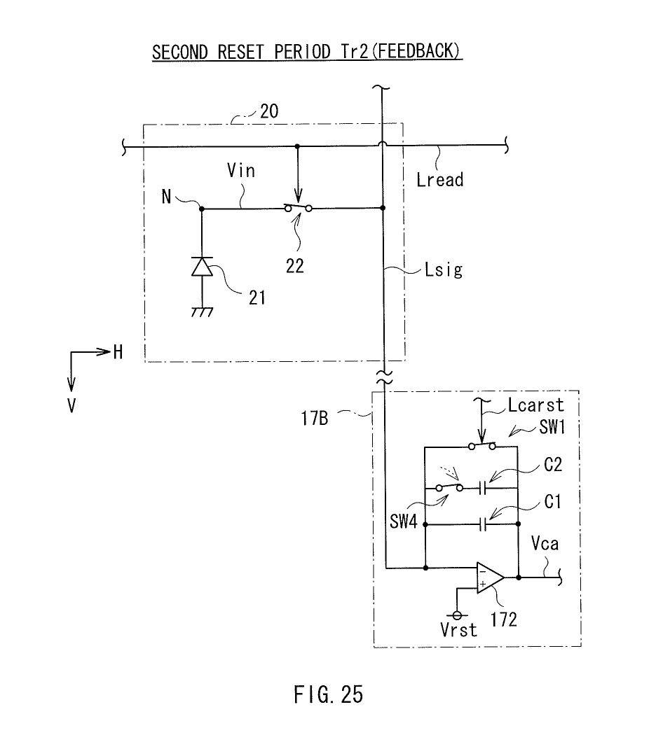

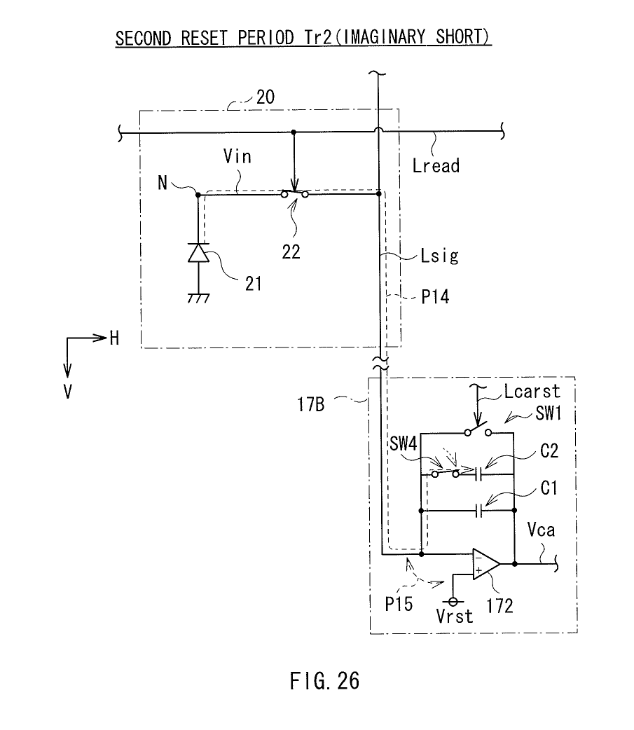

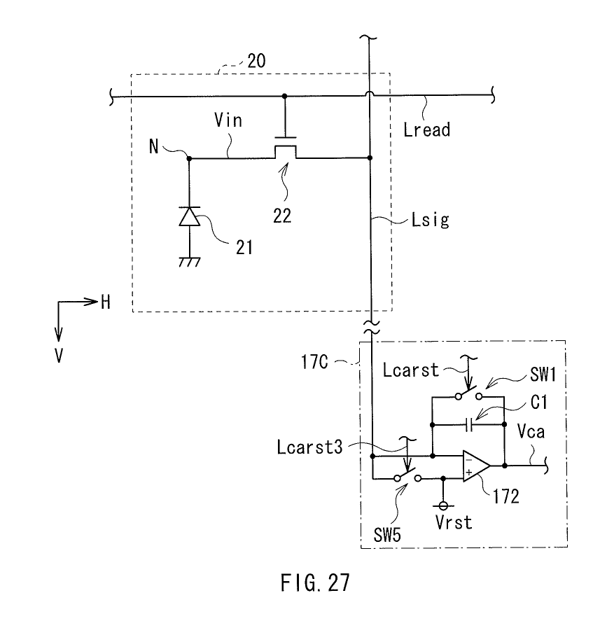

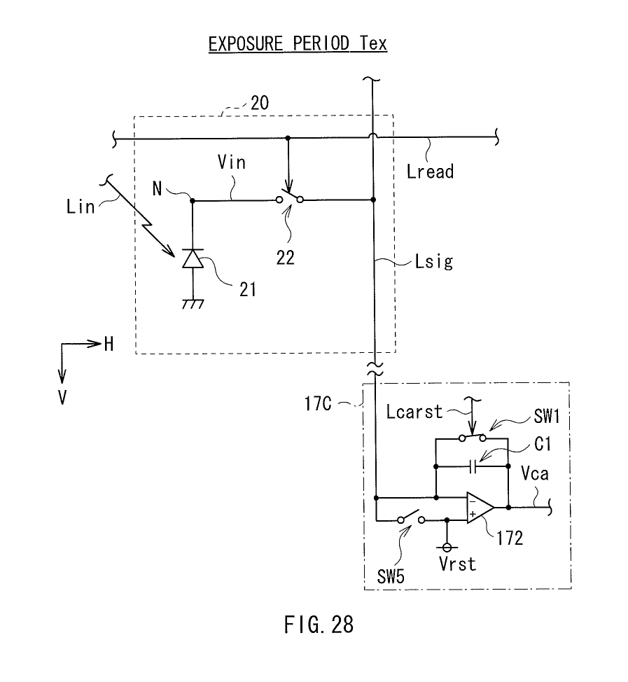

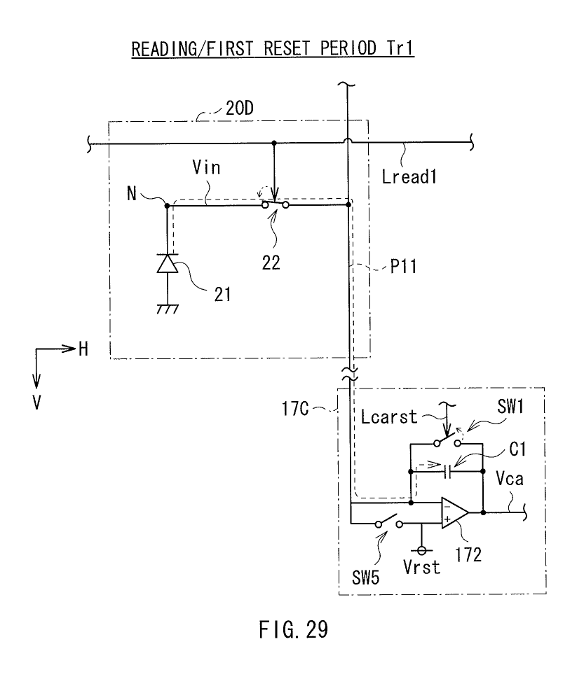

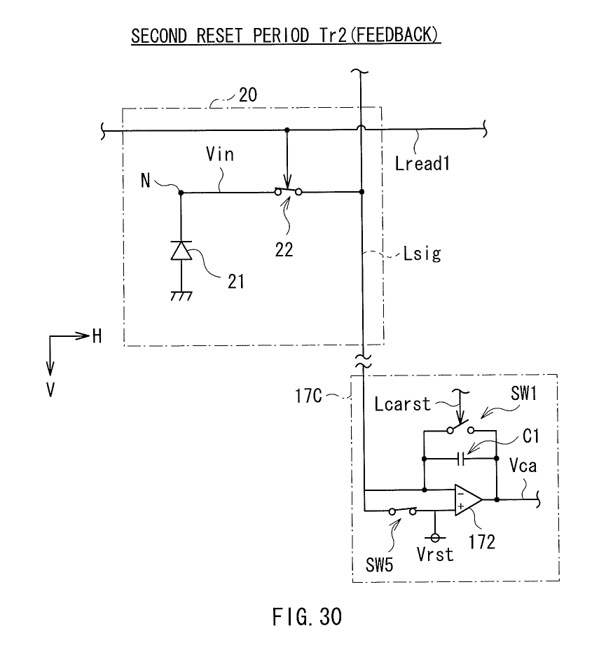

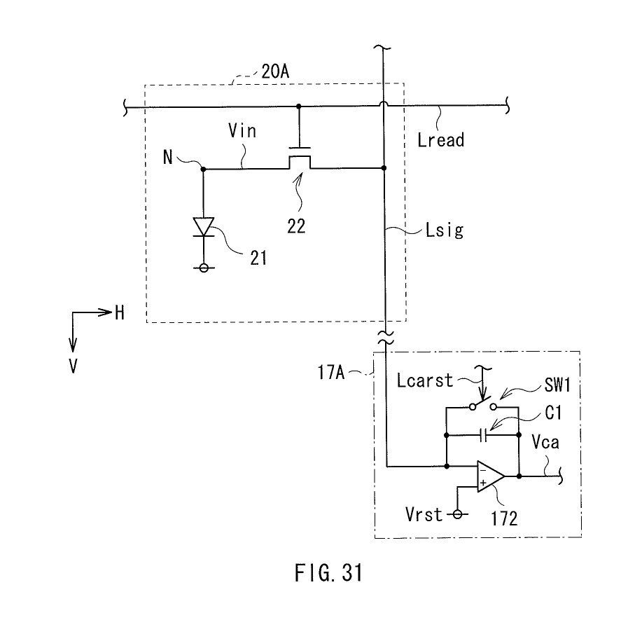

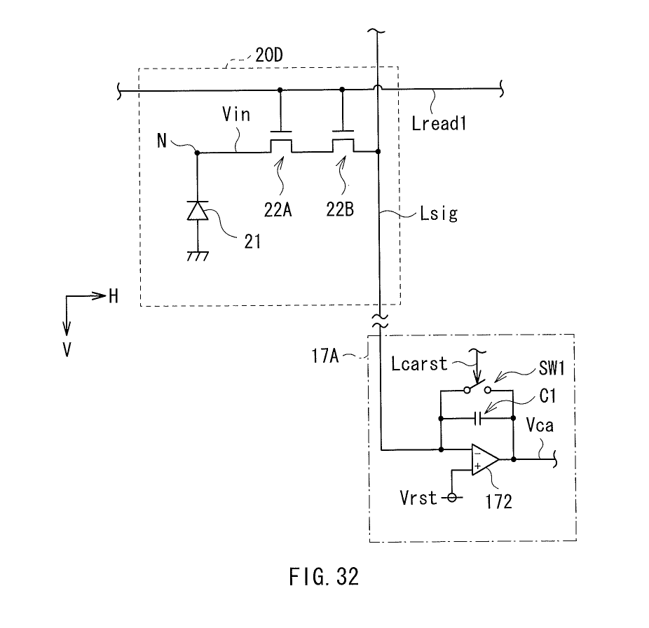

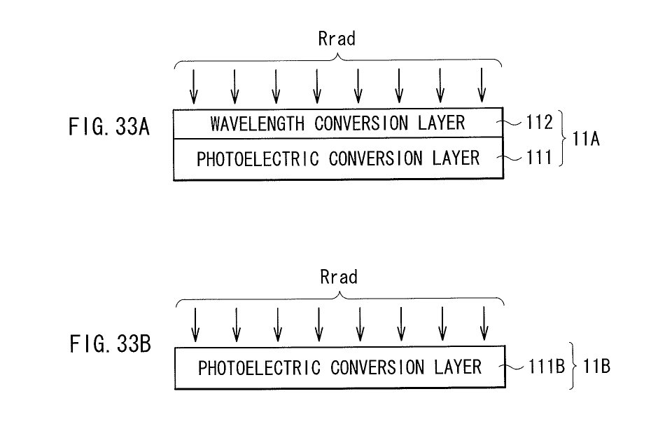

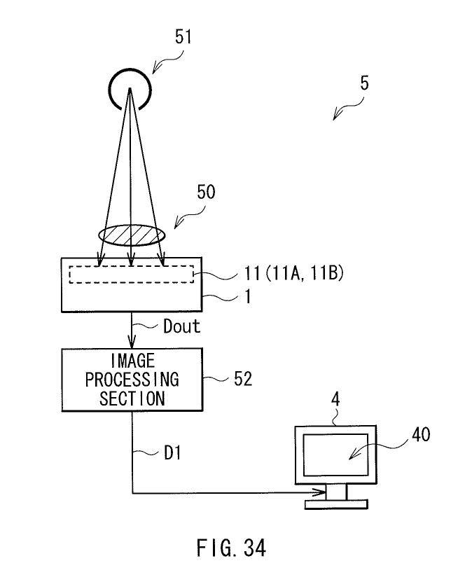

Thus, in the present embodiment, the reset operation is carried out a plurality of times (here, the reset operation is performed twice in total, including the reset operation in the reading/first reset period Tr1 described above). Further, reading driving and the reset driving are performed line-sequentially as will be described later. Specifically, the reading driving and the reset driving performed a plurality of times are carried out as single line-sequential driving. This reduces the above-described remaining charge, thereby suppressing an afterimage resulting from this remaining charge. Specifically, as illustrated in FIG. 14, in one vertical period (one frame period) ΔTv, after the reading operation and the first reset operation are carried out in the period Tr1 following the exposure period Tex, the second reset operation is performed during the second reset period Tr2 subsequent to a predetermined time interval. Further, among these, the reading operation and the reset operation in each of the periods Tr1 and Tr2 is line-sequentially performed (line-sequential reading driving and line-sequential reset driving are performed in each of the pixels 20, based on the control of the system control section 16).

### (Example of Line-sequential Driving)

Part (A) of FIG. 15 to Part (E) of FIG. 18 illustrate an example of timing of each operation in the line-sequential image pickup driving (the line-sequential reading driving and the line-sequential reset driving). Part (A) to Part (F) of FIG. 15 illustrate an example of the line-sequential image pickup driving according to the present embodiment, in a timing waveform diagram. Here, Part (A) to Part (F) illustrate timing waveforms of electric potentials Vread(1) to Vread(3) and Vread(n−2) to Vread(n) of the reading control lines Lread(1) to Lread(3) and Lread(n−2) to Lread(n), respectively. “ΔTh” illustrated in the figures represents one horizontal period (one horizontal scanning period). Part (D) of each of FIGS. 16 to FIG. 18 illustrates an electric potential Vcarst of the amplifier reset control line Lcarst in the above-described first operation example, and Part (E) of each of FIGS. 16 to FIG. 18 illustrates an electric potential Vcarst of the amplifier reset control line Lcarst in the above-described second operation example.

In the line-sequential image pickup driving, as illustrated in Part (A) to Part (F) of FIG. 15, for example, there is an overlapping period (a driving overlapping period ΔTol1) between a line-sequential driving period ΔTr1 and a line-sequential driving period ΔTr2. The line-sequential driving period ΔTr1 is a period in which the first reset operation and the like (the operation in the reading/first reset period Tr1) is performed for all the lines. The line-sequential driving period ΔTr2 is a period in which the second reset operation is performed for all the lines.

In the driving overlapping period ΔTol1, the period of each reset operation (i.e. each of the periods Tr1 and the periods Tr2) is set as follows. Specifically, each of the reset periods in the first line-sequential reset driving (each of the periods Tr1 in the line-sequential driving period ΔTr1) and each reset period in the second line-sequential reset driving (each of the periods Tr2 in the line-sequential driving period ΔTr2) are set as follows. That is, each of the reset periods is set so that a non-overlapping period, during which each reading/first reset period Tr1 and each second reset period Tr2 do not overlap each other, is present at least in a part of the driving overlapping period ΔTol1 (for example, see a period indicated with P5 in Part (A) to Part (F) of FIG. 15). Part (A) to Part (E) of FIG. 16 are enlarged diagrams of a portion in the vicinity of the period indicated with P5.

As illustrated in Part (A) to Part (E) of FIG. 16, during the driving overlapping period ΔTol1, each reset driving is performed without an overlap between the reading/first reset period Tr1 and the second reset period Tr2. In this example, during the period indicated with P5, the electric potential Vread equivalent to the row scanning signal (an ON potential Von1 or an ON potential Von2) is applied, in the order of Vread(2) (the second reset period Tr2), Vread(n−2) (the reading/first reset period Tr1), and Vread(3) (the second reset period Tr2). During another period indicated with P5 illustrated in Part (A) to Part (E) of FIG. 17, for example, the electric potential Vread is applied in the order of Vread(n−2) (the reading/first reset period Tr1), Vread(2) (the second reset period Tr2), and Vread(3) (the second reset period Tr2). Further, during still another period indicated with P5b illustrated in Part (A) to Part (E) of FIG. 18, the above-described non-overlapping period is provided only partially in each of the reading/first reset periods Tr1 and each of the second reset periods Tr2 within the driving overlapping period ΔTol1. In other words, an overlapping period (an operation overlapping period ΔTo12) is present in a part between the reading/first reset period Tr1 and the second reset period Tr2. In all of these examples, the non-overlapping period is provided at least in a part of the driving overlapping period ΔTol1.

The timing and the like of each operation in the line-sequential image pickup driving are realized by the row scanning section 13 having the unit circuits 130 illustrated in FIG. 4, for example. Specifically, the timing and the like are realized by the shift register circuits 131 and 132 and logical circuits (the AND circuits 133A to 133D and the OR circuits 134A and 134B). The shift register circuits 131 and 132 are provided in a plurality of columns to correspond to the number of times the line-sequential reset driving is carried out. The logical circuits each generate the logical sum signal between the output signals from the shift register circuits 131 and 132 of the respective columns, while controlling the validity period of each of the output signals.

As described above, the non-overlapping period is set at least in a part of the period of the reset operation (the reading/first reset period Tr1 and the second reset period Tr2) within the driving overlapping period ΔTol1 between the line-sequential driving period ΔTr1 and the line-sequential driving period ΔTr2. This makes it possible to freely set the period, the timing, and the like of each reset operation in the line-sequential reset driving performed a plurality of times. In the example illustrated in Part (A) to Part (E) of FIG. 18, the non-overlapping period between the reading/first reset period Tr1 and the second reset period Tr2 is set only in a part of the driving overlapping period ΔTol1. In this example, in particular, an increase in speed (an increase in frame rate) of the line-sequential image pickup driving is realized, as compared with the other examples (Part (A) to Part (E) of FIG. 16, and Part (A) to Part (E) of FIG. 17).

It is to be noted that in contrast to the row scanning section 13 of the present embodiment realizing such operation timing and the like, it is difficult to perform, in an ordinary row scanning circuit (a gate driver circuit), operation in each of pixels connected to different scanning lines, based on timing and the like at which there is no overlap in at least a part thereof.

The image pickup driving operation for one line in such line-sequential image pickup driving will be described below in detail.

Part (A) of FIG. 19 illustrates a timing waveform of the electric potential Vread of the reading control line Lread. Part (B) of FIG. 19 illustrates a timing waveform of the output voltage Vca derived from the charge amplifier 172. Part (C) of FIG. 19 illustrates a timing waveform of an electric potential Vsig of the signal line Lsig. Part (D) of FIG. 19 illustrates a timing waveform of the electric potential Vn of the storage node N. It is to be noted that each of these timing waveforms is for a period including one frame period ΔTv as well as periods before and after this one frame period ΔTv.

In the one frame period ΔTv, at first, exposure operation is performed as described above (FIG. 7A) during the exposure period Tex (timings t11 to t12), and in the photoelectric transducer 21 in each of the pixels 20, the image pickup light Lin incident thereon is converted into the signal charge (i.e. subjected to the photoelectric conversion). Then, this signal charge is stored at the storage node N in the pixel 20, and therefore the electric potential Vn of the storage node N gradually changes (as indicated with P31 in Part (D) of FIG. 19). Here, since the cathode side of the photoelectric transducer 21 is connected to the storage node N, the electric potential Vn gradually decreases from the reset voltage Vrst side to 0 V during the exposure period Tex.

Next, in the reading/first reset period Tr1 (timings t13 to t14), along with the reading operation, the reset operation (the first reset operation) is performed using the imaginary short in the charge amplifier circuit 17A, as described above (FIG. 7B). At the subsequent timing t15, the switch SW1 in the charge amplifier circuit 17A enters the ON state, thereby the electric charge stored in the capacitive device C1 in this charge amplifier circuit is reset (the amplifier reset operation is carried out).

However, after this reading/first reset period Tr1, for the above described reasons, the remaining charge q1 is generated, and the electric potential Vn of the storage node N gradually decreases (as indicated with P32 in Part (D) of FIG. 19). Thus, after the reading/first reset period Tr1, the second reset operation is performed in the subsequent second reset period Tr2 (timings t16 to t17) after a lapse of a predetermined time interval.

### (Second Reset Operation)

In the second reset period Tr2, the second reset operation is performed using the feedback or the imaginary short of the charge amplifier in the charge amplifier circuit 17A. Specifically, when the feedback is used, the transistor 22 in the pixel 20 is the ON state and also, the switch SW1 in the charge amplifier circuit 17A is in the ON state as illustrated in FIG. 20A. Thereby, the voltage follower circuit using the charge amplifier 172 is formed. Therefore, in the charge amplifier 172, the voltage on the input terminal side on the negative side (the signal line Lsig side) becomes substantially equal to the reset voltage Vrst applied to the input terminal on the positive side, due to the feedback properties. In this way, in the first operation example, the electric potential Vn of the storage node N in the pixel 20 is changed to the reset voltage Vrst (the second reset operation is performed), by using the feedback in the charge amplifier 172.

Alternatively, when the imaginary short is used, the operation similar to the first reset operation is performed as illustrated in FIG. 20B (as indicated with P42 in the figure). In other words, in a reading operation state (i.e. the transistor 22 is in the ON state, and the switch SW1 is in the OFF state) of the charge amplifier circuit 17A, the second reset operation is carried out. The electric potential Vn of the storage node N in the pixel 20 is changed to the reset voltage Vrst by this imaginary short as well. In this example, the charge amplifier circuit 17A is in the reading operation state and thus, it is possible to read the electric charge remaining in the storage node N as indicated with an arrow P41 in the figure.

Here, the electric charge read in the second reset operation is equivalent to the remaining charge stored in the storage node N after the original reading operation (the reading operation in the reading/first reset period Tr1). Fort this reason, the signal charge read in the second reset operation corresponds to noise or an afterimage. Therefore, generating the output data Dout based on such signal charge and using this, for example, in image arithmetic processing also allows afterimage correction in the picked-up image.

In the present embodiment, the reset operation of the stored charge in the pixel 20 is carried out a plurality of times intermittently during one frame period. Specifically, here, the first reset operation (in the reading/first reset period Tr1) and the second reset operation (in the second reset period Tr2) are performed with a predetermined time interval therebetween. Then, of these, the second reset operation, in particular, is performed using the feedback or the imaginary short of the charge amplifier circuit 17A, and thereby the remaining charge q1 (the amount of remaining signal charge) in the pixel 20 after the signal charge reading is reduced.

Specifically, when the time from the end of the first reset operation (the end of the period Tr1) to the end of the second reset operation (the end of the period Tr2) is assumed to be Δt12, the reduced electric charge of the remaining charge q1 is as illustrated in FIG. 21, for example. In other words, of the remaining charge q1 described above using, for example, FIG. 12, electric charge q12 corresponding to a time integral from starting time t1 (=0) to finish time t2 of the time Δt12 is allowed to be discharged (reduced) by this second reset operation. It is to be noted that electric charge q23 determined by (q1−q12)=q23 is equivalent to the electric charge remaining after the second reset operation and therefore, it is desirable to set the time Δt12 of a maximum length.

In this way, the remaining charge q1 after the signal charge reading is reduced by performing the reset operation a plurality of times using the charge amplifier circuit 17A. Thus, in the next reading operation (at the time of the image pickup in the next frame period), the occurrence of an afterimage due to this remaining charge is allowed to be suppressed.

It is desirable that the reset operation performed a plurality of times be carried out intermittently, over a period longer than, for example, one horizontal period (one horizontal scanning period: for example, about 32 μs) in the line-sequential driving. The reason for this is as follows. As described above, the state transition in the PIN photodiode takes about several hundred microseconds. Therefore, the generation of the remaining charge is allowed to be reduced by applying the reset voltage Vrst to the storage node N continually or intermittently for about 100 μs, for instance. In fact, when the time period of applying the reset voltage Vrst is longer than the one horizontal period (e.g., about 32 μs), the remaining charge starts decreasing greatly, which has been confirmed by experiments and the like.

In the present embodiment, as described above, the picked-up image based on the incident light is obtained by performing the photoelectric conversion based on the incident light (the image pickup light Lin) in each of the pixels 20 of the image pickup section 11, as well as the reading driving and the reset driving of the signal charge. Within the one frame period, the reset driving is intermittently performed a plurality of times, and the second reset operation is performed using the feedback or the imaginary short of the charge amplifier circuit 17A. Thereby, a reduction in the noise resulting from the remaining of the signal charge after the reading is allowed. Therefore, high quality of the picked-up image is achievable.

It is to be noted that the embodiment has been described using the case in which the reset driving is performed twice during the one frame period, but is not limited thereto. Alternatively, the reset driving may be performed three times or more within the one frame period. In this case, for example, it is desirable to perform the reset operation using the feedback or the imaginary short of the charge amplifier circuit 17A as described above, in or after the second reset driving.

### Second Embodiment

FIG. 22 illustrates a configuration of a charge amplifier circuit (a charge amplifier circuit 17B) according to a second embodiment of the disclosure, together with a circuit configuration of a pixel 20. It is to be noted that the same elements as those of the first embodiment will be provided with the same reference characters as those of the first embodiment, and the description thereof will be omitted as appropriate.

### [Configuration]

The charge amplifier circuit 17B of the second embodiment is provided with, for example, S/H circuits 173, a multiplexor circuit 174, and the like in an A/D conversion section 14 (a column selection section 17), in a manner similar to the charge amplifier circuit 17A of the first embodiment. Further, the charge amplifier circuit 17B performs Q-V conversion similar to that described above in reading operation of each of pixels 20 in an image pickup section 11, and applies a reset voltage Vrst to a storage node N in reset operation. As will be described later in detail, reset operation (first reset operation) is performed with the reading operation for the pixel 20 of a passive type, by using the charge amplifier circuit 17B, and also, the reset operation is performed a plurality of times during one frame period, in the second embodiment as well.

The charge amplifier circuit 17B includes, for example, a charge amplifier 172, a capacitive device C1, and a switch SW1, like the charge amplifier circuit 17A of the first embodiment. In addition, a signal line Lsig is connected to an input terminal on a negative side of the charge amplifier 172, and the reset voltage Vrst is inputted into an input terminal on a positive side (plus side). Meanwhile, between an output terminal and the input terminal on the negative side of the charge amplifier 172, the capacitive device C1 and the switch SW1 are each connected in parallel.

However, in the second embodiment, another capacitive device C2 (a capacitor, a feedback capacitive device) is further connected in parallel between the output terminal and the input terminal on the negative side of the charge amplifier 172. In addition, to this capacitive device C2, a switch SW4 is connected in series. In other words, for example, one terminal of the capacitive device C2 is connected to the output terminal of the charge amplifier 172, and the other terminal of the capacitive device C2 is connected to the switch SW4. One terminal of the switch SW4 is connected to the capacitive device C2, and the other terminal of the switch SW4 is connected to the input terminal on the negative side of the charge amplifier 172. It is to be noted that the ON/OFF state of the switch SW1 is controlled by a control signal supplied from a system control section 16 through an amplifier reset control line Lcarst. In addition, the ON/OFF state of the switch SW4 is similarly controlled by a control signal supplied from the system control section 16 through an amplifier reset control line Lcarst2.

The capacitive device C2 is connected in parallel between the output terminal and the input terminal on the negative side of the charge amplifier 172, together with the capacitive device C1, thereby making feedback connection between the output terminal and the input terminal of the charge amplifier 172. Connecting the switch SW4 to this capacitive device C2 in series and switching the ON/OFF state of this switch SW4 allow a feedback capacity in the charge amplifier circuit 17B to be variable. Here, the capacity is capable of being switched between two levels (a capacity cf1 of the capacitive device C1, and a synthetic capacity cf2 of the capacitive devices C1 and C2), by using these two capacitive devices C1 and C2.

It is desirable that this capacitive device C2 have, for example, a capacity larger than that of the capacitive device C1. The reason is as follows. The capacitive device C2 is connected in parallel to a circuit formed of the capacitive device Cl and the switch SW1, by the ON control of the switch SW4, thereby forms the synthetic capacity with the capacitive device C1. However, in the second reset operation in particular, noise is effectively reduced using the larger capacity in the charge amplifier circuit 17B.

### [Function and Effects]

In the second embodiment, image pickup light Lin entering the image pickup section 11 is subjected to photoelectric conversion in each of the pixels 20, and signal charge generated thereby is stored in the storage node N, in a manner similar to the first embodiment. When the transistor 22 enters the ON state, the stored electric charge is read to the signal line Lsig. The signal charge thus read to the signal line Lsig undergoes Q-V conversion in the charge amplifier circuit 17B in an A/D conversion section 14 (the column selection section 17) and then, output data Dout (image pickup signals) is generated. In this way, the image pickup driving operation is performed. Now, exposure operation, reading operation, and reset operation using the charge amplifier circuit 17B will be described below.

FIG. 23 illustrates an operation example of each of the pixel 20 and the charge amplifier circuit 17B in an exposure period Tex. FIG. 24 illustrates an operation example of each of the pixel 20 and the charge amplifier circuit 17B in a reading/first reset period Tr1. It is to be noted that, here, likewise, the ON/OFF state of the transistor 22 is illustrated using a switch for convenience of description.

First, as illustrated in FIG. 23, the transistor 22 is in the OFF state in the exposure period Tex, like the first embodiment. In this state, the signal charge based on the image pickup light Lin is stored at the storage node N, without being outputted (without being read) to the signal line Lsig side. On the other hand, the charge amplifier circuit 17B is in a state after amplifier reset operation is performed, and therefore, the switch SW1 is in the ON state. As a result, a voltage follower circuit is formed. At this moment, in the charge amplifier circuit 17B, the switch SW4 is in the OFF state.

Next, as illustrated in FIG. 24, in the reading/first reset period Tr1, the transistor 22 enters the ON state, and thereby the signal charge is read from the storage node N to the signal line Lsig (see an arrow P11 in the figure). The read signal charge is inputted into the charge amplifier circuit 17B. On the other hand, in the charge amplifier circuit 17B, the switch SW1 is in the OFF state (the charge amplifier circuit enters a reading operation state). At this moment, the switch SW4 is also in the OFF state. Therefore, the signal charge inputted into the charge amplifier circuit 17B is stored in the capacitive device C1, and a signal voltage (an output voltage Vca) corresponding to the stored charge is outputted from the charge amplifier 172.

At this moment, in the second embodiment, the reset operation (the first reset operation) is performed accompanying the reading operation, in a manner similar to the first embodiment. In other words, the first reset operation is performed using an imaginary short in the charge amplifier circuit 17B (the charge amplifier 172), as indicated with an arrow P12 in the figure. In this way, in the second embodiment, during the reading/first reset period Tr1, the capacitive device C1 of the capacitive devices C1 and C2 is selectively used, and the storage node N is reset to a predetermined reset voltage Vrst. Subsequently, the switch SW1 enters the ON state, and thereby the electric charge stored in the capacitive device C1 is reset, i.e., the amplifier reset operation is carried out.

The reset operation is performed a plurality of times (here, twice in total including the reset operation in the reading/first reset period Tr1) in order to discharge the charge remaining after the first reset operation, in the second embodiment as well. In addition, the reading driving and the reset driving are performed line-sequentially. The second reset operation in the second embodiment will be described below. An operation example of each of the pixel 20 and the charge amplifier circuit 17B during a second reset period Tr2 is illustrated in each of FIG. 25 and FIG. 26.

During the second reset period Tr2, the second reset operation is performed in the charge amplifier circuit 17B, by using feedback or an imaginary short of the charge amplifier 172, in a manner similar to the first embodiment. In the second embodiment, however, unlike the first embodiment and the reading/first reset period Tr1, the reset operation is performed using the capacitive device C2. Specifically, as illustrated in FIG. 25, when the feedback is used, the transistor 22 in the pixel 20 is in the ON state, and the switch SW1 in the charge amplifier circuit 17B is also in the ON state. The voltage follower circuit is thereby formed. At this moment, in the second embodiment, the switch SW4 is controlled to be ON.

As a result, in the charge amplifier 172, the voltage on the input terminal side on the negative side (the signal line Lsig side) is substantially equal to the reset voltage Vrst applied to the input terminal on the positive side, due to feedback properties. In the first operation example, the electric potential Vn of the storage node N in the pixel 20 thus changes to the reset voltage Vrst (the second reset operation is performed), by using the feedback in the charge amplifier 172.

Alternatively, when the imaginary short is used, the operation similar to the first reset operation is performed as illustrated in FIG. 26. In other words, in the reading operation state (the transistor 22 is the ON state, and the switch SW1 is in the OFF state) of the charge amplifier circuit 17B, the reset operation is performed using the imaginary short (an arrow P15 in the figure) in the charge amplifier circuit 17B (the charge amplifier 172). At this moment, in the second embodiment, the switch SW4 is controlled to be ON. Thus, the reset operation using both the capacitive devices C1 and C2 is performed as indicated with an arrow P14 in the figure (the electric charge is stored in both of C1 and C2).

In other words, in the charge amplifier circuit 17B of the second embodiment, switching of the capacity is enabled by the above-described circuit configuration. Here, binary switching is allowed between the capacity cf1 of the capacitive device C1 and the synthetic capacity made of the capacity cf1 and the capacity cf2 of the capacitive device C2. This makes it possible to appropriately use the capacity used in the reading/first reset period Tr1 and the capacity used in the second reset period Tr2. As described above, while the signal charge based on the image pickup light Lin is read using only the capacitive device C1 (the capacity cf1) at the time of the first reset operation (in the reading operation), the greater capacity (the capacity cf2) is allowed to be used at the time of the second reset operation. This makes it possible to lower a gain of the charge amplifier 172 at the time of the second reset, and, as a result, noise in the output signal is allowed to be reduced. When the imaginary short is used, the charge amplifier circuit 17B is in the reading operation state, and therefore, the electric charge stored in the storage node N is allowed to be read out at the time of the second reset operation, in the second embodiment as well.

In this way, in the second embodiment, the reset operation of the stored charge in the pixel 20 is carried out a plurality of times intermittently during one frame period. Such reset operation performed a plurality of times using the charge amplifier circuit 17B allows a reduction in remaining charge q1 (the amount of remaining signal charge) in the pixel 20, and high image quality in a picked-up image is achievable.

Next, modifications (modifications 1 to 7) of the first and second embodiments will be described. It is to be noted that the same elements as those of the above-described embodiments will be provided with the same reference characters as those of these embodiments, and the description thereof will be omitted as appropriate

### (Modification 1)

FIG. 27 illustrates a configuration of a charge amplifier circuit (a charge amplifier circuit 17C) according to the modification 1, together with a circuit configuration of the pixel 20. The charge amplifier circuit 17C is provided together with, for example, the S/H circuits 173, the multiplexor circuit 174, and the like in the A/D conversion section 14 (the column selection section 17), like the charge amplifier circuit 17A of the first embodiment. In addition, similarly, the charge amplifier circuit 17C includes, for example, the charge amplifier 172, the capacitive device C1, and the switch SW1. The signal line Lsig is connected to the input terminal on the negative side of the charge amplifier 172, and the reset voltage Vrst is inputted into the input terminal on the positive side. Further, between the output terminal and the input terminal on the negative side of the charge amplifier 172, the capacitive device C1 and the switch SW1 are connected in parallel.

However, in the charge amplifier circuit 17C of the modification 1, a switch SW5 is provided between the input terminal on the positive side of the charge amplifier 172 and one end of the signal line Lsig. The reset voltage Vrst is thereby allowed to be inputted into the one end of the signal line Lsig through the switch SW5. It is to be noted that the ON/OFF state of the switch SW1 is controlled by the control signal supplied from the system control section 16 through the amplifier reset control line Lcarst. This also applies to the ON/OFF state of the switch SW5, which is controlled by a control signal supplied from the system control section 16 through an amplifier reset control line Lcarst3.

The reset operation performed a plurality of times described above is enabled also by using the charge amplifier circuit 17C having such a switch SW5. Further, the first reset operation is performed accompanying the reading operation. Each of the exposure operation, the first reset operation, and the second reset operation using the charge amplifier circuit 17C will be described below.

First, as illustrated in FIG. 28, the transistor 22 is in the OFF state during the exposure period Tex, like the first embodiment. In this state, the signal charge based on the image pickup light Lin is stored at the storage node N, without being outputted (without being read) to the signal line Lsig side. Meanwhile, the charge amplifier circuit 17C is in a state after the completion of the amplifier reset operation and thus, the switch SW1 is in the ON state. As a result, the voltage follower circuit is formed. At this moment, in the charge amplifier circuit 17C, the switch SW5 is in the OFF state.

Next, as illustrated in FIG. 29, during the reading/first reset period Tr1, the transistor 22 enters the ON state, and thereby the signal charge is read from the storage node N to the signal line Lsig (see an arrow P11 in the figure). The read signal charge is inputted into the charge amplifier circuit 17C. Meanwhile, in the charge amplifier circuit 17C, the switch SW1 is in the OFF state (the charge amplifier circuit is in the reading operation state). At this moment, the switch SW5 is also in the OFF state. Therefore, the signal charge inputted into the charge amplifier circuit 17C is stored in the capacitive device C1, and the signal voltage (the output voltage Vca) corresponding to the stored charge is outputted from the charge amplifier 172. In this way, in the modification 1, the reset operation (the first reset operation) is carried out accompanying the reading operation, in a manner similar to the first embodiment.

Further, as illustrated in FIG. 30, during the second reset period Tr2, while the transistor 22 in the pixel 20 is in the ON state, the switch SW1 in the charge amplifier circuit 17C is in the OFF state and the switch SW5 is in the ON state. Thereby, the electric potential Vn of the storage node N changes to the reset voltage Vrst (the second reset operation is performed). In this way, the reset driving may be carried out a plurality of times, by using the charge amplifier circuit 17C having the switch SW5.

### (Modification 2)

FIG. 31 illustrates a circuit configuration of a pixel (a pixel 20A) according to the modification 2, together with the circuit configuration example of the charge amplifier circuit 17A. The pixel 20A of the modification 2 has a so-called passive circuit configuration, like the pixel 20 of each of the first and second embodiments. The pixel 20A includes the one photoelectric transducer 21 and the one transistor 22. In addition, the reading control line Lread extending along the H direction and the signal line Lsig extending along the V direction are connected to this pixel 20A.

However, in the pixel 20A of the modification 2, unlike the pixel 20 of each of the first and second embodiments, the anode of the photoelectric transducer 21 is connected to the storage node N, and the cathode of the photoelectric transducer 21 is connected to, for example, a power source. In this way, in the pixel 20A, the storage node N may be connected to the anode of the photoelectric transducer 21. Even in this case, effects similar to those of the image pickup unit 1 of each of the first and second embodiments are achievable.

### (Modification 3)

FIG. 32 illustrates a circuit configuration of a pixel (a pixel 20D) according to the modification 3, together with the circuit configuration example of the charge amplifier circuit 17A. The pixel 20D of the modification 3 has a so-called passive circuit configuration, like the pixel 20 of each of the first and second embodiments, and includes the one photoelectric transducer 21. The pixel 20D is connected to the reading control line Lread extending along the H direction and the signal line Lsig extending along the V direction. It is to be noted that, here, the description will be provided by taking the charge amplifier circuit 17A of the first embodiment as an example, but this may be replaced with the charge amplifier circuit 17B of the second embodiment or the charge amplifier circuit 17C of the modification 1.

In the modification 3, however, the pixel 20D includes two transistors (transistors 22A and 22B). These two transistors 22A and 22B are connected in series to each other (i.e. a source or a drain of one of the transistors 22A and 22B is electrically connected to a source or a drain of the other). Further, a gate in each of the transistors 22A and 22B is connected to the reading control line Lread.

In this way, the two transistors 22A and 22B connected in series may be provided in the pixel 20D. Even in this case, a reduction in noise is enabled by performing the reading driving and the reset driving similar to those in the above-described embodiments.

### (Modifications 4 and 5)

FIGS. 33A and 33B illustrate schematic configurations of the respective image pickup sections (image pickup sections 11A and 11B) according to the modifications 4 and 5, respectively.

The image pickup section 11A according to the modification 4 illustrated in FIG. 33A includes a wavelength conversion layer 112 on the photoelectric conversion layer 111 (on a light-receiving surface side) described in the first embodiment. The wavelength conversion layer 112 converts the wavelengths of radiation rays Rrad (e.g., alpha rays, beta rays, gamma rays, X-rays, and the like) into those in a sensitivity range of the photoelectric conversion layer 111. This enables reading of information based on the radiation rays Rrad, in the photoelectric conversion layer 111. The wavelength conversion layer 112 is made of a fluorescent substance (e.g., a scintillator) that converts, for example, radiation rays such as X-rays into visible light. The wavelength conversion layer 112 is obtained by, for example, forming a flattening film made of an organic material, a spin-on-glass material, or the like, on a photoelectric conversion layer 1113, and then forming a fluorescent film by using CsI, NaI, CaF₂, and/or the like, for example, on the flattening film. This image pickup section 11A is applied to, for example, a so-called indirect radiation image-pickup unit.

The image pickup section 11B according to the modification 5 illustrated in FIG. 33B includes a photoelectric conversion layer 111B that converts the incident radiation rays Rrad into electric signals, unlike the above-described embodiments. The photoelectric conversion layer 111B is configured using an amorphous selenium (a-Se) semiconductor, a cadmium tellurium (CdTe) semiconductor, or the like. This image pickup section 11B is applied to, for example, a so-called direct radiation image-pickup unit.

The image pickup unit with the image pickup section 11A according to the modification 4 or the image pickup section 11B according to the modification 5 is used as any of various types of radiation image-pickup units which obtain electric signals based on the incident radiation rays Rrad. The image pickup unit is applicable to, for example, medical X-ray image-pickup units (such as Digital Radiography), belongings inspection X-ray image-pickup units used at airports and the like, industrial X-ray image-pickup units (for example, inspection units used to check dangerous objects and the like in containers, and inspection units used to check the contents in bags and the like), and the like.

### APPLICATION EXAMPLE

The image pickup unit according to each of the embodiments and the modifications (the modifications 1 to 5) is applicable to an image pickup display system described below.

FIG. 34 illustrates a schematic configuration example of an image pickup display system (an image pickup display system 5) according to an application example. The image pickup display system 5 includes the image pickup unit 1 having the image pickup section 11 (11A or 11B) according to any of the embodiments and the like. The image pickup display system 5 further includes an image processing section 52, and a display unit 4. In this example, the image pickup display system 5 is configured as an image pickup display system using a radiation (i.e. a radiation image pickup display system).

The image processing section 52 generates image data D1 by subjecting the output data Dout (the image pickup signals) outputted from the image pickup unit 1, to predetermined image processing. The display unit 4 displays an image based on the image data D1 generated by the image processing section 52, on a predetermined monitor screen 40.

In this image pickup display system 5, the image pickup unit 1 (here, the radiation image-pickup unit) acquires image data Dout of a subject 50, based on irradiation light (here, the radiation) emitted to the subject 50 from a light source (here, a radiation source such as an X-ray source) 51. The image pickup unit 1 then outputs the acquired image data Dout to the image processing section 52. The image processing section 52 subjects the inputted image data Dout to the above-mentioned predetermined image processing, and then outputs the image data (display data) D1 after the image processing to the display unit 4. The display unit 4 displays image information (a picked-up image) on the monitor screen 40, based on the inputted image data Dl.

In this way, in the image pickup display system 5 of this application example, the image of the subject 50 is allowed to be acquired as electric signals in the image pickup unit 1. Therefore, image display is enabled by transmission of the acquired electric signals to the display unit 4. In other words, the image of the subject 50 is allowed to be viewed without using a radiographic film usually used, and further, photography and display of a moving image are also possible.

It is to be noted that this application example has been described using the case where the image pickup unit 1 is configured as the radiation image-pickup unit, and the image pickup display system is configured to use the radiation. However, the image pickup display system of the disclosure is also applicable to systems using other types of image pickup units.

The disclosure has been described with reference to the embodiments, the modifications, and the application example, but is not limited thereto and may be variously modified. For example, the circuit configuration of the pixel in the image pickup section may be other circuit configuration, without being limited to that described with reference to each of the embodiments and the like (i.e. the circuit configurations of the pixels 20, 20A, and 20D). Similarly, the circuit configuration of each of the row scanning section, the column selection section, and the like may be other circuit configuration, without being limited to that described with reference to each of the embodiments and the like.

In addition, in the second embodiment, the capacity is switchable between the two levels by changing the switch (the switch SW4) in the charge amplifier circuit 17B, but alternatively, a configuration in which the capacity is switchable among three or more levels may be adopted. For example, the capacity may be adjustable in multiple stages, by connecting two or more groups, each formed of a capacitive device and a switch connected in series to this capacitive device, to the capacitive device C1 in parallel, and controlling the ON/OFF state of the switch in each of the groups appropriately.

Further, each of the image pickup section, the row scanning section, the A/D conversion section (the column selection section), and the column scanning section described in each of the embodiments and the like may be formed on the same substrate, for example. Specifically, the switches and the like in these circuit parts may be formed on the same substrate, by using, for instance, a polycrystalline semiconductor such as a low-temperature polycrystal silicon. Therefore, for example, driving operation may be performed on the same substrate, based on a control signal from an external system control section. This allows a narrower frame (a frame structure of three free sides) and an improvement in reliability in wiring connection to be realized.

It is to be noted that the present disclosure may be configured as follows.

(1) An image pickup unit including:
an image pickup section having a plurality of pixels each including a photoelectric transducer; and
a drive section performing reading driving and reset driving of signal charge stored in each of the pixels, wherein
the drive section includes a charge amplifier circuit converting the read signal charge into a voltage,
the drive section performs the reset driving a plurality of times intermittently during one frame period, and
the drive section performs each reset driving within the one frame period, by using feedback or an imaginary short of a charge amplifier in the charge amplifier circuit.

(2) The image pickup unit according to (1), wherein the charge amplifier circuit includes:
a charge amplifier having a first terminal and a second terminal on an input side, the first terminal being connected to a signal line of each of the pixels, and the second terminal being maintained at a reset potential;
a first capacitive device connected in parallel between the first terminal on the input side of the charge amplifier, and a terminal on an output side of the charge amplifier; and
a first switch connected in parallel to the charge amplifier and the first capacitive device.

(3) The image pickup unit according to (2), wherein the drive section performs the reset driving using the feedback, by maintaining the first switch in an ON state.

(4) The image pickup unit according to (2), wherein the drive section performs the reset driving using the imaginary short, by maintaining the first switch in an OFF state.

(5) The image pickup unit according to any one of (2) to (4), wherein the charge amplifier circuit further includes:
a second capacitive device connected in parallel between the first terminal on the input side of the charge amplifier, and the terminal on the output side of the charge amplifier; and
a second switch connected in series to the second capacitive device.

(6) The image pickup unit according to (5), wherein the drive section performs the reset driving using the feedback, by maintaining the first switch in an ON state, and the second switch in an OFF state.

(7) The image pickup unit according to (5), wherein the drive section performs the reset driving using the imaginary short, by maintaining the first switch in an OFF state, and the second switch in an ON state.

(8) The image pickup unit according to any one of (5) to (7), wherein the drive section maintains the first switch in an ON state, and the second switch in an OFF state, in exposure operation of the pixel, and the drive section maintains both the first and second switches in an OFF state, in the reading driving.

(9) The image pickup unit according to (8), wherein the drive section performs a first reset driving accompanying the reading driving, by maintaining both the first and second switches in the OFF state.

(10) The image pickup unit according to any one of (5) to (9), wherein the second capacitive device has a capacity larger than a capacity of the first capacitive device.

(11) The image pickup unit according to any one of (1) to (10), wherein the reset driving using the imaginary short is performed in a state in which the charge amplifier circuit is capable of reading the signal charge.

(12) The image pickup unit according to any one of (1) to (11), wherein the photoelectric transducer is a PIN photodiode or an MIS sensor.

(13) The image pickup unit according to any one of (1) to (12), wherein the image pickup section generates an electric signal based on an incident radiation.

(14) The image pickup unit according to (13), wherein the image pickup section includes a wavelength conversion layer on the photoelectric transducer, the wavelength conversion layer converting a wavelength of the radiation into a wavelength within a sensitivity range of the photoelectric transducer.

(15) The image pickup unit according to (14), wherein the radiation is an X-ray.

(16) The image pickup unit according to any one of (1) to (15), wherein
each of the pixels further includes a transistor, and
the transistor includes a semiconductor layer made of an amorphous silicon, a polycrystal silicon, a micro-crystal silicon, or an oxide semiconductor.

(17) An image pickup display system including an image pickup unit and a display unit performing image display based on an image signal obtained by this image pickup unit, the image pickup unit including:
an image pickup section having a plurality of pixels each including a photoelectric transducer; and
a drive section performing reading driving and reset driving of signal charge stored in each of the pixels, wherein
the drive section includes a charge amplifier circuit converting the read signal charge into a voltage,
the drive section performs the reset driving a plurality of times intermittently during one frame period, and
the drive section performs each reset driving within the one frame period, by using feedback or an imaginary short of a charge amplifier in the charge amplifier circuit.

The disclosure contains subject matter related to that disclosed in Japanese Priority Patent Application JP 2011-230128 filed in the Japan Patent Office on Oct. 19, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image pickup unit comprising:
an image pickup section having a plurality of pixels each including a photoelectric transducer; and
a drive section performing reading driving and reset driving of signal charge stored in each of the pixels, wherein
the drive section includes a charge amplifier circuit converting the read signal charge into a voltage,
the drive section performs the reset driving a plurality of times intermittently during one frame period, and
the drive section performs each reset driving within the one frame period, by using feedback or an imaginary short of a charge amplifier in the charge amplifier circuit.

2. The image pickup unit according to claim 1, wherein the charge amplifier circuit includes:
a charge amplifier having a first terminal and a second terminal on an input side, the first terminal being connected to a signal line of each of the pixels, and the second terminal being maintained at a reset potential;
a first capacitive device connected in parallel between the first terminal on the input side of the charge amplifier, and a terminal on an output side of the charge amplifier; and
a first switch connected in parallel to the charge amplifier and the first capacitive device.

3. The image pickup unit according to claim 2, wherein the drive section performs the reset driving using the feedback, by maintaining the first switch in an ON state.

4. The image pickup unit according to claim 2, wherein the drive section performs the reset driving using the imaginary short, by maintaining the first switch in an OFF state.

5. The image pickup unit according to claim 2, wherein the charge amplifier circuit further includes:
a second capacitive device connected in parallel between the first terminal on the input side of the charge amplifier, and the terminal on the output side of the charge amplifier; and
a second switch connected in series to the second capacitive device.

6. The image pickup unit according to claim 5, wherein the drive section performs the reset driving using the feedback, by maintaining the first switch in an ON state, and the second switch in an OFF state.

7. The image pickup unit according to claim 5, wherein the drive section performs the reset driving using the imaginary short, by maintaining the first switch in an OFF state, and the second switch in an ON state.

8. The image pickup unit according to claim 5, wherein
the drive section maintains the first switch in an ON state, and the second switch in an OFF state, in exposure operation of the pixel, and
the drive section maintains both the first and second switches in an OFF state, in the reading driving.

9. The image pickup unit according to claim 8, wherein the drive section performs a first reset driving accompanying the reading driving, by maintaining both the first and second switches in the OFF state.

10. The image pickup unit according to claim 5, wherein the second capacitive device has a capacity larger than a capacity of the first capacitive device.

11. The image pickup unit according to claim 1, wherein the reset driving using the imaginary short is performed in a state in which the charge amplifier circuit is capable of reading the signal charge.

12. The image pickup unit according to claim 1, wherein the photoelectric transducer is a PIN photodiode or an MIS sensor.

13. The image pickup unit according to claim 1, wherein the image pickup section generates an electric signal based on an incident radiation.

14. The image pickup unit according to claim 13, wherein the image pickup section includes a wavelength conversion layer on the photoelectric transducer, the wavelength conversion layer converting a wavelength of the radiation into a wavelength within a sensitivity range of the photoelectric transducer.

15. The image pickup unit according to claim 14, wherein the radiation is an X-ray.

16. The image pickup unit according to claim 1, wherein
each of the pixels further includes a transistor, and
the transistor includes a semiconductor layer made of an amorphous silicon, a polycrystal silicon, a micro-crystal silicon, or an oxide semiconductor.

17. An image pickup display system including an image pickup unit and a display unit performing image display based on an image signal obtained by this image pickup unit, the image pickup unit comprising:
an image pickup section having a plurality of pixels each including a photoelectric transducer; and
a drive section performing reading driving and reset driving of signal charge stored in each of the pixels, wherein
the drive section includes a charge amplifier circuit converting the read signal charge into a voltage,
the drive section performs the reset driving a plurality of times intermittently during one frame period, and
the drive section performs each reset driving within the one frame period, by using feedback or an imaginary short of a charge amplifier in the charge amplifier circuit.
